(19) United States
(12) Patent Application Publication
(10) Pub. No.: US 2004/0245227 A1
(43) Pub. Date: Dec. 9, 2004

(54) System and method for delivering an energy beam to selected impinge points on a work piece

(76) Inventors: Clive Grafton-Reed, Broughton Astley (GB); Simon George Caiger, Cawston (GB)

Correspondence Address: MAINE & ASMUS, 100 MAIN STREET, P O BOX 3445, NASHUA, NH, 03061-3445, US

(21) Appl. No.: 10/484,873

(22) PCT Filed: Jul. 25, 2002
(86) PCT No.: PCT/GB02/03401

(30) Foreign Application Priority Data
Jul. 26, 2001 (GB) 0118307.8

(51) Int. Cl. B23K 26/03; B23K 26/06

(52) U.S. Cl. 219/121.83; 219/121.63; 219/121.74; 700/166

(57) ABSTRACT

A system for laser processing a work piece surface with a laser processing beam includes a processing beam delivery source (205) optics (210, 230) for focusing the processing beam at a surface of the work piece, a viewing camera (250) configured coaxially and coincidently focused with the processing beam (207) at beam impinge point (245) on the work piece (100). The system further includes a computer (510) and processor (512) for displaying an image of the work piece (100) and a cursor (600) superimposed thereon on a monitor (560). One or more movable mirrors (320, 325) are provided movably mounted on galvanometers (335, 340) controlled by the processor (512) to direct the processing beam to selected points on the work surface for processing, (e.g. by laser spot welding). The system further includes an input device such as a mouse (520) for positioning a movable cursor (600) on image points of the work piece image and for selecting the image point for laser processing. The image points may be stored in a memory (514) as a pattern of image points laser processed as a patter under automatic control by the processor (512).

### TECHNICAL FIELD

The present invention generally relates to energy beam delivery, and more particularly to automated energy beam delivery, for implementations such as spot welding or otherwise processing micro-devices with an energy beam.

### BACKGROUND ART

FIG. 1 depicts an exemplary micro-device in the form of an amplifier 100 on a support table 150, which is used to support the amplifier during fabrication. As shown, the amplifier 100 includes a base 105 having a laser chip 110 and fiber optic element 115 supported thereon. The base 105 may, for example, have a length of approximately 12.25 mm, (0.5 inches). The base 105 includes pads 107 and 109. The fiber optic 115 is encased in a hypo-tube 120, which, for example, could have a diameter of approximately 1.4 millimeters, (0.06 inches).

During fabrication, the fiber optic element 115 is first moved into proper alignment with the laser chip 110, so that when placed in operation, a laser beam emitted from the laser chip 110 is in precise alignment with the longitudinal axis of the fiber optic 115 and at a distance 111 from the laser chip 110 that is consistent with coupling as much of the laser beam into the fiber optic 115 as is practical. Accordingly, the fiber optic 115 may require alignment with respect to three transnational axes and two rotational axes. In order to mount the fiber optic 115 in the desired position for the required laser beam coupling into the fiber optic 115, a fiber optic holding bracket 112 is attached to the fiber optic 115 and provides a right “tab” 125 and left “tab” 130 on either side of the fiber optic 115 for securing the clamped fiber optic to the base 105. The tabs 125 and 130 are typically formed in the form of small flat pieces of metal and may have a width of approximately 2 millimeters, (0.08 inches) and length of approximately 3 millimeters, (0.12 inches).

To mount the fiber optic 115, the tabs 125 and 130, are spot welded to pads 107 and 109 formed on the base 105 in a position, which will hold the fiber optic in its desired position, ie. in alignment with the laser chip. In the exemplary device shown in FIG. 1, five spot-welds 140 are used to mount each of the tabs 125 and 130 to the pads 107 and 109.

With reference to FIG. 2, traditionally, a multi-axis positioning device, sometimes called a drill stand (not shown) supports the support table 150. The drill stand provides precise movement of the support table in at least two axes for moving the work piece with respect to a fixed welding laser beam and may further provide a third translation motion perpendicular to the welding plane for positioning the welding plane at a focal point of the welding laser beam. A laser spot welding beam delivery subsystem 200, disposed above the drill stand, is used to spot weld the tabs 125 and 130 to the pads 107 and 109 of the base 105. As shown in FIG. 2, the laser spot welding beam delivery subsystem 200 includes a laser beam source, shown being delivered via fiber optic 205, which emits a laser beam 207. The beam 207 is collimated by the lens 210, and directed to a mirror 215, which reflects the beam onto first and second fixed mirrors 220 and 225, which could be eliminated since they only serve to redirect the beam to another axis. The beam is directed by mirrors 220 and 225 through a focus lens 230 and onto the amplifier 100 to form a desired spot weld, eg spot weld 140, at the desired location 245.

As will be described further below, a closed circuit television (CCTV) camera 250 is co-axially aligned with the laser beam 207 such that a line of sight of the camera is coincident with the point where the beam 207 will impinge the amplifier 100. The camera 250 detects light reflected from surfaces of the amplifier 100. The reflected light is deflected by the mirrors 220 and 225, and passes through the mirror 215, which is partially transmisive, and is reflected by a mirror 255 onto a sensor (not shown) within the camera 250. An image of the entire, or more typically only a portion of the amplifier 100, is generated by the camera 250 from the detected light and displayed on a display monitor 260. The monitor 260 presents the image to the operator for viewing.

Traditionally, the operator winds, ie. physically moves, a handle on the drill stand to move the entire table 150 in one or more of the three motion axes to thereby position the amplifier 100 supported thereon, such that each location requiring one of the spot welds 140 is shown by the display monitor 260 to be positioned so as to be impinged by a laser spot welding beam 207 emitted from the fiber optic 205. Cross hairs 265, or another visual indicator, are displayed on the monitor 260 to identify the center of the line of sight of the video camera 250, which is coincident with the laser beam. Accordingly, an operator moves the support table, using the drill stand, to position the amplifier 100 such that the exact location at which a laser spot weld is to be placed is coincident with the crosshairs 265. That is, the operator identifies each weld location 245 by moving the table 150 while viewing the output of a coaxial camera displayed on a monitor 260, to move the table 100 to align location 245 on the amplifier 100 at the desired weld point. Moreover, the location 245 is coincident with the crosshairs 265. As noted above, only the relevant part of the amplifier 100 is typically detected and imaged by the camera 250 and hence displayed on the monitor 260. Once an operator has selected a weld position, the table 100 is positioned to place the weld position at position 245 and the operator presses one or more weld fire buttons (not shown) to make the weld, eg one of the welds 140.

Because the operator must judge and decide where to position each spot weld 140 and manually move the table support 150 to appropriately position the amplifier for the spot weld, the above described traditional alignment technique was a very slow process and prone to errors. Furthermore, a welding pattern, such as the pattern of welds 140 on each tab 125 and 130, often needs to be repeated on multiple amplifiers 100 during a batch. However, typically the tabs etc. will have some dimensional variation from amplifier to amplifier, which in many cases will be significant in the context of properly locating the spot welds. Hence, it was difficult to automate the process by pre-selecting a pattern of spot weld locations and automatically position the table 150, eg by numerically controlled (NC) methods. Accordingly, a substantial amount of time and labor has been required. Additionally, the traditional technique has various drawbacks from an ergonomic standpoint, which are well recognized by those skilled in the art.

Referring again to FIG. 1, the same spot welding technique was traditionally performed on the “saddle” 145 in a final stage alignment. The saddle 145 is typically another metal component that is fit over the fiber hypo tube 120 after the spot welding of the tabs 125 and 130 with spot-welds 140. The feet of the saddle 145 are welded to the base 105 by a pattern of individual spot welds 155. The sides of the saddle 145 are then welded to the hypo tube 120 by the opposed individual spot welds 160 to fix the tube 120 along its longitudinal axis.

Although the above description has been given in the context of movement of the support table 150, it will be recognized that the above-described traditional technique could be easily adapted to a movable laser spot welding beam delivery subsystem 200 and a stationary support table. More particularly, if desired, the laser spot welding beam delivery subsystem 200, rather than the support table 150 would be mounted onto a drill stand equipped with the manually operated handles for moving the laser beam impinge point 245 with respect to the fixed amplifier 100. In such a case, the operator would wind, ie. physically move, the handles to move the subsystem 200, and thereby image a desired portion of the amplifier 100 supported by the stationary support table 150 such that each location requiring one of the spot welds 140 is shown by the display monitor 260 to be positioned coincident with the crosshairs 265 so as to be impinged at selected weld locations by a laser spot welding beam 207 emitted from the fiber optic 205.

More recent conventional systems automate the alignment process. More particularly, the above described movement of the support table 150 or laser spot welding beam delivery subsystem 200 has been automated to eliminate the need for an operator to physically move the handles to align the location 245 so the beam 207 will impinge on the amplifier 100 at the desired point.

In these conventional systems, automated motion control is substituted for the traditional physical movement of the handles to drive the alignment of the amplifier and welding beam. Typically, an operator enters commands into a computer using either a keyboard or joystick based on the image displayed on the display monitor. The commands are transformed into drive signals and transmitted to a translation stage to move either the support table 150 or laser spot welding beam delivery subsystem 200. The movement is driven by motors based on the drive signals to align desired weld points of the amplifier to be coincident with the location 245 so the beam 207 will impinge on the amplifier 100 at the proper point.

As shown in FIG. 3, currently offered systems utilize a fixed support table and a fixed laser spot welding beam delivery subsystem, with moveable deflecting mirrors 320 and 325. More particularly, moveable deflecting mirrors 320 and 325 are substituted for the previously utilized fixed mirrors, 220 and 225 of FIG. 2, in the laser spot welding beam delivery subsystem 300. The deflectors 320 and 325 are respectively mounted for limited rotation about a single axis such as by galvanometer motors, (galvo's) 335 and 340, which are electronically controlled by a servo, drive system, not shown.

An exemplary conventional control subsystem 400 shown in FIG. 4A can be used to command the galvo's 335 and 340, and thereby control the movement of the deflecting mirrors 320 and 325 to direct the laser beam 207 and the line of sight of the camera 250 over a range of points in the welding plane. Accordingly, the rotational angles of the deflecting mirrors 320 and 325 are controlled to direct the point 245 to a desired location on the amplifier 100 for spot welding. Coincidently, the line of sight of the camera 250 moves with the point 250 such that the crosshairs 565 remain coincident with the point 245 during movement of the mirrors 320 325.

As shown the control subsystem 400 includes the display monitor 460 interconnected to a computer 410. The computer 410 includes a processor 412 and memory 414. The processor receives inputs from the previously described camera 250 and processes these inputs in accordance with logic, typically in the form of software, stored in the memory 414 to drive the display of an image of the amplifier 100, or more typically a portion of the amplifier, on the display monitor 260.

The processor 412 is also configured to receive operator inputs via the keys 422 of a keyboard 420 and/or joystick 430 and to process these inputs in accordance with logic stored in the memory 414, to generate commands for rotating the galvo's 335 and 340, which in turn drive the movement of the deflectors 320 and 325, thereby changing the field of view of the camera 450 and hence the image of the amplifier, or more typically a portion of the amplifier 100, appearing on the display monitor 460 being viewed by the operator.

Using the command subsystem 400, the operator manipulates the keys 422 or joystick 430 while viewing an image of the amplifier 100 on the display monitor 460 to orient the deflecting mirrors 320 325 such that an image of each desired spot weld location has been displayed at the crosshairs 465. Crosshairs 465 are displayed on the monitor 460 to identify the exact location at which the laser spot welding beam 207 emitted from the fiber optic 205 will impinge upon the amplifier 100 with the galvo's in their current position. That is, the operator identifies each weld location 245 by viewing the output of a coaxial camera 450 displayed on a monitor 460, while the amplifier 100 is supported by the table support 150, and entering inputs which result in the galvo's being commanded to drive the movement of the deflectors until each weld location 245 is displayed so as to be exactly aligned with the displayed crosshairs 465. Once a weld position for a weld point eg location 245, has been identified, the operator presses one or more weld fire buttons, eg one or more keys 422, to make the weld, eg one of the welds 140.

FIGS. 4B and 4C depict images displayed on the display monitor both before and after manipulation of the keys 422 or joystick 430 by the operator to align the weld point 245 with the crosshairs 265. As shown in FIG. 4B, the originally displayed image of a portion of the amplifier 100 depicts the laser beam and camera line of sight aimed at a point on the hypo tube 120, ie. the point coincident with the crosshairs 265 superimposed on the displayed image. In this particular example, the operator wishes to place a spot weld on tab 130. Accordingly, the operator manipulates the keys 422 or joystick 430 to continuously move the deflecting mirrors 320 325 until the crosshair 265 appears coincident with the desired location for making a spot-weld, eg 140 as shown in FIG. 4C.

Although current systems allow an operator to more easily align the laser beam with the desired location on a device while viewing a displayed image of the device, the use of a keyboard or joystick to control the multi-directional movement often required to bring the desired weld location onto the crosshairs of the display monitor is difficult for many operators. In part, this is due to the tedious nature of fine motor manipulation of a joy stick and to the discrete step size that is provide by keying a step command to move the galvo's. In addition, the operator must manipulate the keys or joystick to make the alignment, without having any specific pre-indication of how the manipulation will affect what is displayed. Accordingly, what the operator has been tasked to do has proven to be very difficult and time consuming even for those accustomed to manipulating keys or a joystick.

Additionally, although current conventional systems allow the operator to predefine and store a pattern of weld locations that may be automatically sequenced by computer or numerical control, these systems do not allow the operator to easily review multiple weld locations prior to or during the pattern being used to perform a desired operation, such as forming welds in the predefined pattern of welds.

Furthermore, in performing a desired automatic operation, there may be a need to adjust a weld pattern, due for example to flaws in a work-piece, or a variation in the position of elements to be welded from one amplifier 100 to another. However, current conventional systems lack the functionality necessary to easily determine if such an adjustment is required or to make the necessary adjustment.

It is often necessary to adjust the height, or what is sometimes also referred to as z-axis location, of the work piece or scan head to weld elements in more than on weld plane or to simply optimize the interaction of the laser beam with the elements to be welded. Most typically, the desired z-axis location for any given weld will coincide with that at which the work piece will be impinged by the energy beam within its focal depth of field. For example, in defining a pattern of welds, the height of the work piece or the laser beam focus position may need to be varied either due to variations in the desired planes at which the welds will be made or to a poor focus condition at the work piece surface. Furthermore, in performing a desired operation, there may be a need to adjust the z-axis location of the work piece, or laser beam, due to a flaw affecting the height of the work-piece with respect to the desired welding plane. In either case, the height parameter, ie. the z-axis location, must be adjusted to ensure that the emitted energy beam will properly impinge upon the work piece.

Although current conventional systems allow the operator to adjust the height parameter of the work piece or z-axis location of the laser focal point, this adjustment must be performed by the operator entering commands to move the work piece or laser along the z-axis and thereby adjust the distance between the work piece and the laser focal point. For the operator to manipulate the necessary input device to make the correct z-axis adjustment is typically a difficult task. Further, if such an adjustment is required during performance of a desired operation, such as welding, operations must be halted and the predefined pattern modified, making the task often difficult. Additionally, just determining if a height adjustment is required is a difficult task of operators of current conventional systems. This is because using current conventional systems an operator must determine the proper height by either making a test weld or setting the height to obtain a focused image of the applicable area of the work piece on the display monitor. Hence, even though the depth of focus is sometimes different for the camera and the energy emitter, eg the laser, the height is typically set as if these depths of focus were equal.

Current conventional systems have dramatically increased the speed at which a desired operation can be performed. However, there is an ongoing demand to further increase speed at which such operations can be performed. Hence, the next generation of systems will preferably facilitate even faster performance of the desired operations and improve operator ergonomics

It is also well known to use radiation sensors and associated electronics to detect and analyze beam radiation reflected from the work piece during a weld to determine if the weld is being properly made using current conventional systems. For example, if the system is being used to perform the above-described welding operations on a work piece, a conventional sensor could be used to detect a reflected light during welding to obtain a weld signature for each weld. The weld signature can be processed, using any of various well know algorithms, to determine if the weld signature falls within predefined thresholds for a satisfactory weld. If not, the operator is typically notified, for example by a message appearing on the monitor display. It is then up to the operator to determine if the work piece should be retained or discarded and whether or not to stop operations and make adjustments, for example to a height parameter or to the predefined pattern, so that subsequent operations will produce work pieces having satisfactory welds. As discussed above, making such adjustment using conventional systems is quite difficult. Thus, although it has become relatively easy to detect poor quality results of conventional system operations, there is no quick and easy way for the operator to make the necessary adjustments to correct the problem. Accordingly, in practice, operators may ignore received notices of unsatisfactory results to avoid falling behind in production or to simply avoid the additional work required to make the necessary adjustments to the system.

### OBJECTIVES OF THE INVENTION

Accordingly, it is an object of the present invention to overcome one or more of the deficiencies in conventional systems.

It is one object of the invention to increase the speed at which micro-assemblies can be fabricated.

It is a further object of the present invention to reduce the number of unacceptable welds being made in a given pattern or operation.

It is another object of the invention to improve the operator interface with a micro-assembly laser processing device by making the operation of the device easier to understand and implement without the need for the operator using fine motor skills for extended periods.

Additional objects, advantages, novel features of the present invention will become apparent to those skilled in the art from this disclosure, including the following detailed description, as well as by practice of the invention. While the invention is described below with reference to preferred embodiment(s), it should be understood that the invention is not limited thereto. Those of ordinary skill in the art having access to the teachings herein will recognize additional implementations, modifications, and embodiments, as well as other fields of use, which are within the scope of the invention as disclosed and claimed herein and with respect to which the invention could be of significant utility.

### SUMMARY DISCLOSURE OF THE INVENTION

The present invention includes an automated system for directing an energy beam to one or more desired locations on a work piece for processing the work piece with the energy beam, eg for welding, cutting, heat treating, or otherwise processing materials in a manufacturing application, for trimming electronic components to change a performance criteria, eg resistance, for surgery, for weapons targeting, or for any other desired energy beam processing that may required directing an energy beam at a selected point. The system includes one or more moveable beam reflecting mirrors (320, 325) for receiving the energy beam 207 from an energy beam source 205 and movably directing the energy beam onto a surface of the work piece 100. An imager 250 such as a digital video camera 250 having a field of view suitable for viewing a desired region of the work piece (100) is also provided for capturing images of the work surface and generating a video signal corresponding thereto. The video signal may be processed and delivered to a display monitor (560) for displaying the image of the work piece with an operator movable pointer or cursor (600) superimposed thereon by a computer 510. The computer 510 includes an input device such as a mouse (520) configured to move the pointer (600) with respect to the displayed image of the work piece in response to operator movement inputs from the input device (520). The input device (520) is further configured to provide a first operator command to select an energy beam impinge point (245) on the viewed image by positioning the pointer (600) at the selected impinge point (245) and then entering a first input command such as by clicking a first mouse button (524). A processor (512) of the computer (510) is configured to receive the first command and to determine the image coordinates of the selected impinge point (245) and to save those coordinates into a memory 514. The processor (512) is further configured to direct movement of the movable beam reflecting mirrors (320, 325) so that the energy beam (207) can be directed to an impinge point (245) selected by the operator. The system is further configured to store operator selected weld points, (140) as a pattern of welds or processing positions with each position being identified by three spatially coordinates. The system may also be configured with means for adjusting the work piece position with respect to the focal point of the process beam.

### BRIEF DESCRIPTION OF DRAWINGS

FIG. 1 depicts an exemplary micro-device on a support table during fabrication.

FIG. 2 depicts a conventional laser spot welding beam delivery subsystem.

FIG. 3 depicts a more recent conventional laser spot welding beam delivery subsystem.

FIG. 4A depicts a conventional control subsystem for commanding the spot-welding beam delivery subsystem depicted in FIG. 3.

FIG. 4B depicts a displayed portion of the micro-device depicted in FIG. 1 prior to operator inputs being processed by the control subsystem of FIG. 4A.

FIG. 4C depicts a displayed portion of the micro-device depicted in FIG. 1 after operator inputs have been processed by the control subsystem of FIG. 4A.

FIG. 5 depicts a control subsystem for commanding the spot-welding beam delivery subsystem depicted in FIG. 3, in accordance with the present invention.

FIG. 6A depicts a displayed portion of the micro-device depicted in FIG. 1 prior to operator inputs being processed by the control subsystem of FIG. 5.

FIG. 6B depicts a displayed portion of the micro-device after first operator inputs have been processed by the control subsystem of FIG. 5.

FIG. 6C depicts a displayed portion of the micro-device after second operator inputs have been processed by the control subsystem of FIG. 5.

FIG. 7 depicts a displayed portion of the micro-device after another operator input for setting a stop.

FIG. 8A depicts a display presented to the operator on the display monitor of the control subsystem depicted in FIG. 5, during the weld pattern definition.

FIG. 8B depicts a display presented to the operator on the display monitor of the control subsystem depicted in FIG. 5, during welding operations.

FIG. 9 depicts a laser spot welding beam delivery subsystem having a HeNe/red diode, in accordance with the present invention.

FIG. 10 is a flowchart of a process for automatically retraining the control subsystem during welding operations to adjust the weld locations in the pattern, in accordance with the present invention.

FIG. 11A depicts a first embodiment of a laser spot welding dual beam delivery subsystem, in accordance with the present invention.

FIG. 11B depicts a second embodiment of a laser spot welding dual beam delivery subsystem, in accordance with the present invention.

FIG. 12 depicts a laser spot welding beam delivery subsystem having a height sensor, in accordance with the present invention.

FIG. 13 depicts a laser spot welding beam delivery subsystem having a weld sensor, in accordance with the present invention.

### BEST MODE FOR CARRYING OUT THE INVENTION

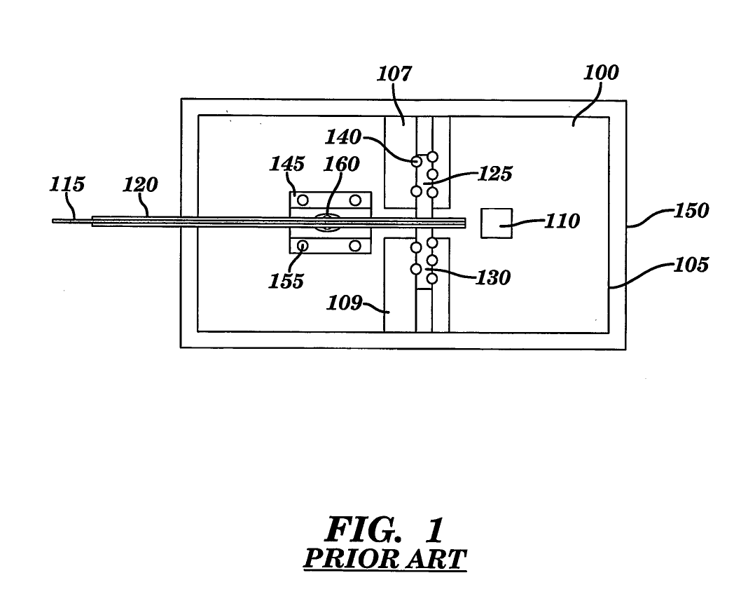

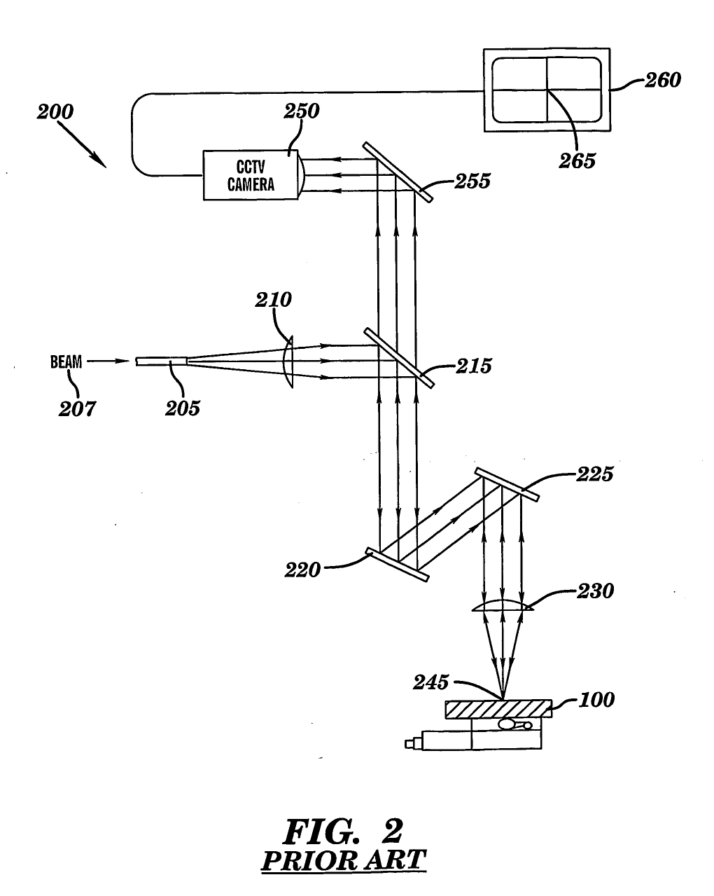

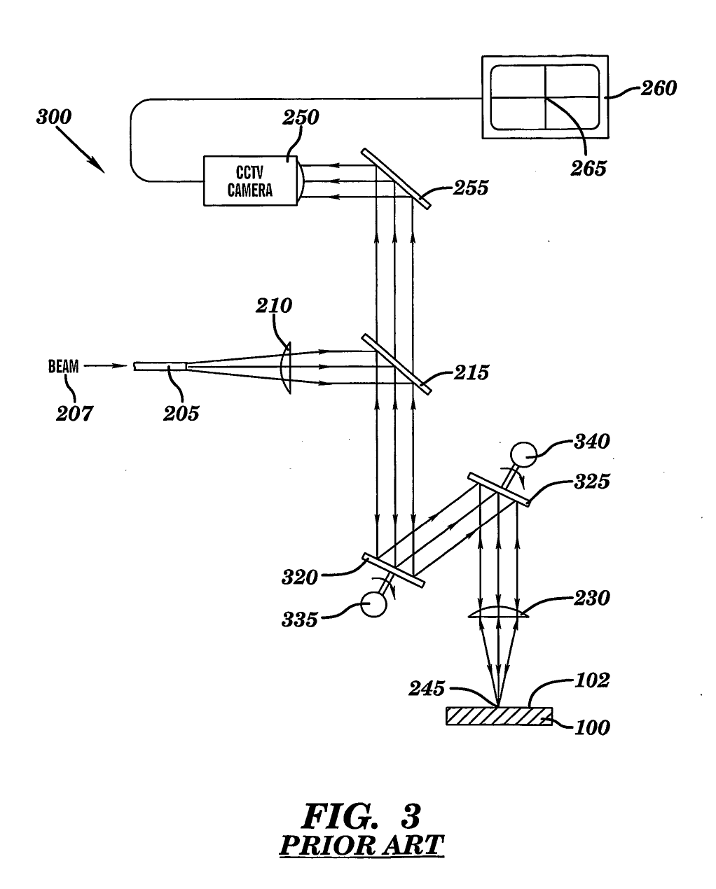

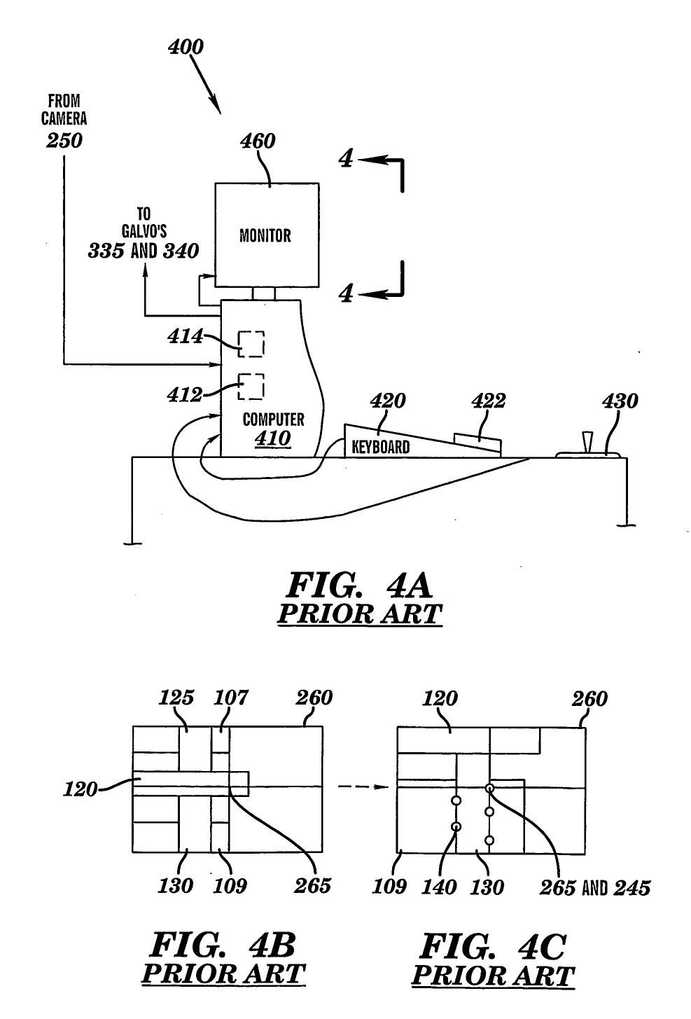

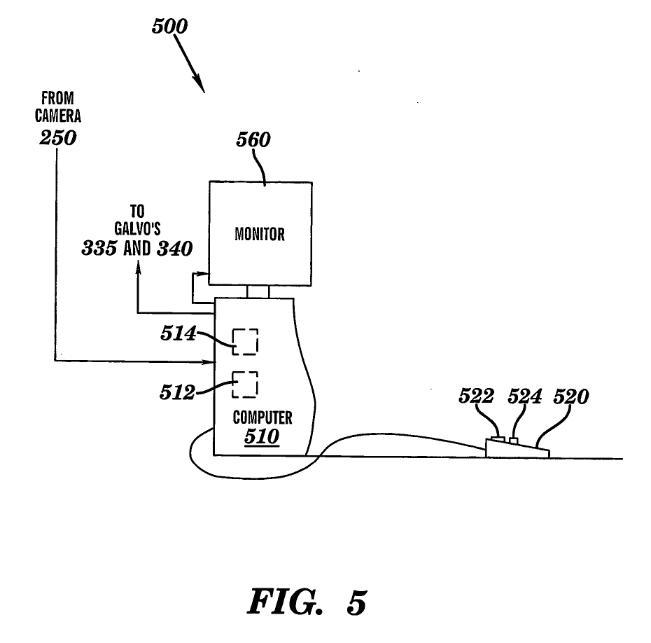

FIG. 5 depicts a control subsystem 500 which can be used to command the galvo's 335 and 340, and thereby control the movement of the deflecting mirrors 320 and 325, of the spot welding beam delivery subsystem depicted in FIG. 3, in accordance with the present invention. Of course the control subsystem 500 may be used to control numerous other laser material processing systems such as systems for laser drilling, laser heat treating, other types of laser welding, electronic element trimming or processing, laser surgery, and any other system where it is desired to direct an energy beam, eg a laser beam onto a targeted area of a work piece in either one, two or three dimensional space. As shown the control subsystem 500 includes a display monitor 560 interconnected to a computer 510. The computer 510 includes a processor 512 and memory 514. The processor receives a video input from a camera 250 and processes the video input in accordance with logic, typically in the form of software, stored in the memory 514, to drive the display of an image of the amplifier 100 or other micro-assembly or work piece depicted in FIG. 1, or more typically, the display of a portion of the amplifier 100, on the display monitor 560.

The processor 512 is also configured to receive operator inputs via a mouse 520. Keys and/or a joystick or any other operator input device, (not shown) could be used in lieu of or in addition to the mouse 520, if so desired. In any event, the processor 512 processes the received operator inputs in accordance with the logic stored in the memory 514, to generate commands for rotating the galvo's 335 and 340, which in turn rotate the deflecting mirrors 320 and 325. The movement of the deflecting mirrors redirects a line of sight of the camera 250 such that a center of the field of view of the camera 250 may be scanned over portions of the amplifier 100, or another work piece, to display various portions of the amplifier 100 on the display monitor 560. In general, the work piece will be viewed at high magnification such that the entire work piece may not be viewable in the field of view of the camera.

Referring again to FIG. 3, the work piece 100 includes a work surface 102, which is planar in the example. The laser beam 207 is substantially collimated by the lens 210 and remains substantially collimated until the focus lens 230 focuses it at the impinge point 245. In most applications, it is desirable that any processing done by the laser beam will occur when the laser beam is optimally focused at the work surface 102. As will be detailed below, several systems will be detailed for ensuring that the work surface and the laser focal point remain substantially coincident. For the purposes of simplifying this disclosure the impinge point (245) will designate a point on the surface of the work piece 102 having eg X and Y coordinates with respect to a system reference point and the impinge point (245) will also designate the position of the optimal focal point of the laser processing beam. As will be detailed below, there are ways to locate the impinge point (245) coincident with the work surface 102 and to monitor any changes in the processing that may occur if the beam is not optimally focused with respect to the work surface 102. This is done by either moving the work surface 102 with respect to the impinge point 245 or by moving the entire laser delivery system 300 with respect to the work piece 100 or by changing the beam focal point, eg by moving the either of the lenses 210 and 230. It is also desirable that the laser process beam impinges the work surface 102 substantially perpendicular thereto over the entire work surface to be processed. This is accomplished by configuring the lens 230 telecentrically with respect to the work surface 102 and the deflecting mirrors 320 325.

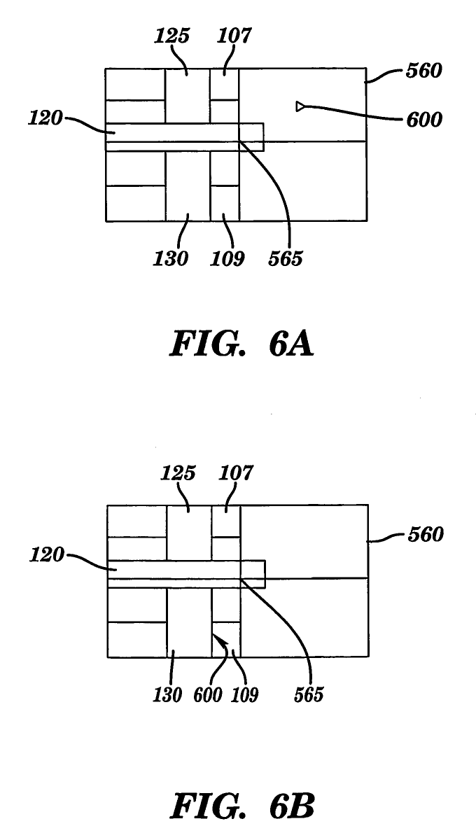

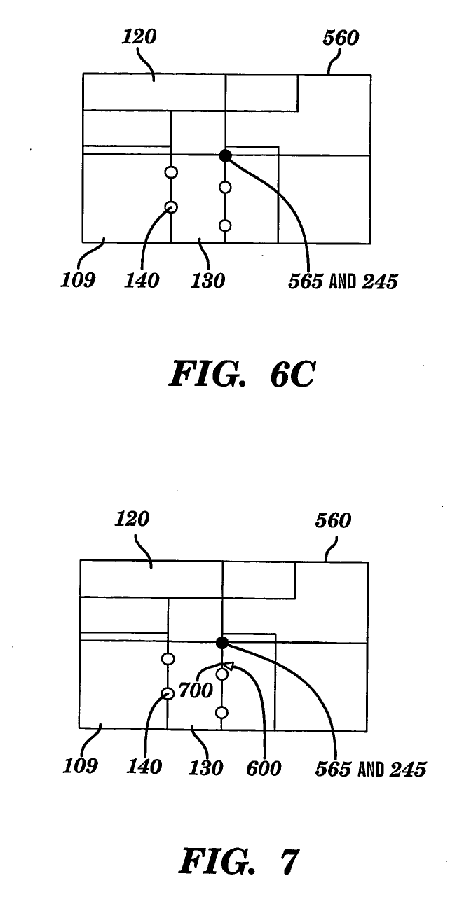

Using the control subsystem 500 depicted in FIG. 5 and the display monitor views shown in FIGS. 6A-C, the operator manipulates the mouse 520, or a joystick or any other operator input device, while viewing an image of the work surface 102 on the display monitor 560. The mouse movements are related to the movement of a displayed cursor 600 or other visual indicator, by the computer 510. The cursor 600 is superimposed over a camera image displayed onto the display monitor in a manner well known in the art

Also according to the present invention, a position on the display device is indicated by the location of intersecting crosshairs with a center 565, hereafter referred to as crosshairs 565. In the present embodiment, the crosshairs 565 are not moveable but are permanently displayed on the display screen in a fixed location. Alternately, the crosshairs 565 may be marked or otherwise affixed to the display device in a fixed position. The laser beam 207, which, in the present invention is modulated to fire only on command, is directed to impinge the amplifier 100 by the mirror 215 and the deflecting mirrors 320 and 325. In accordance with the invention, the pointing direction of the laser beam 207 and the line of sight of the camera 250 are calibrated such that the impinge point 245 of the laser beam 207 and the line of sight of the camera 250 are coincident at the work piece surface 102. Moreover, the system is further configured so that the impinge point and the camera line of sight are coincident with the location of the crosshairs 565 displayed on the display device 560. The system is further configured such that both the camera viewing system and the laser-processing beam are coincidentally in focus at the work piece surface 102. Accordingly, by moving the deflecting mirrors 320 and 325 the center of the camera field of view and the laser impinge point are scanned over the of the work piece surface 102 and an operator will know that the laser beam will be directed to impinge the work piece surface 102 at a point on the displayed image that is coincident with the crosshairs 565. According to one aspect of the present invention, an operator can view the work piece surface 102 on the monitor 560 and use a mouse to select an impinge point displayed on the monitor, by placing the cursor (600) on the selected impinge point and clicking a mouse button to either command the system to direct the laser processing beam at the selected location or to click and drag the selected impinge point to the crosshairs (565). When doing so the processor 512 is programmed to simultaneously move the camera line of sight and the laser processing beam to impinge the work surface 102 at the selected impinge point by moving the deflecting mirrors 320 325. A fire command can then be given to fire the laser with enough energy to place a spot weld at the selected impinge point, which is now displayed at the location indicated by the crosshairs 565.

More particularly, in a first mode of operation, the operator manipulates the mouse 520 while viewing an image of the amplifier 100 on the display monitor 560 to enter cursor movement inputs with respect to the image. These movement inputs are processed by the processor 512, in accordance with logic stored at the memory 514, to generate commands, which result in movement of the displayed cursor 600 to a desired location on the displayed image of the amplifier 100. Using the cursor an operator positions the cursor over a first point of the displayed image where a spot-weld is desired to be located or where it is desired to direct the line of sight of the camera. Once the cursor has been moved to the desired location, or first point, the operator enters a first command, eg by clicking a first button, eg a right button 524, on the mouse 520 to enter or store the location of the first point in a computer memory 514. The processor 512 processes this input, in accordance with the logic stored at memory 514, to generate further commands for directing the galvo's 335 and 340 to reposition the deflectors 320 and 325 to direct the laser processing beam impinge point (245) and the camera line of sight to impinge the amplifier 100 at the first point. In this manner, an operator may select a location to be laser welded or otherwise laser processed by moving the displayed cursor 600 to the location thereby providing movement input. Once the location is selected, a first operator command is issued to indicate that the cursor 600 is positioned at the selected location with respect to the displayed image. Upon entering the first command, eg by clicking the right mouse button 524 on mouse 520, the selected location will be stored in the memory 514 and angles will be calculated for moving the deflecting mirrors 320 325 to direct the impinge point 245 to impinge the amplifier 100 at the first point. Upon entering a second command, eg by releasing the right button 524, the processor 512 commands the deflecting mirrors 320 325 to rotate through the calculated angles to direct the laser impinge point 245 and the camera line of sight to the first point. Using a third operator command, the laser may be fired to form a spot weld at the selected first point. It will also be recognized that the image of the amplifier 100 displayed on monitor 560 will change as the camera line of sight is moved by the mirror 320 325 to the selected first point. After the mirrors 320 325 have been rotated, the selected first point will be coincident with the crosshairs 565, which are preferably located at the center of the display screen. It is also noted that the step of entering the third operator command may be automated and initiated by the processor 512 such that merely selecting a location on the amplifier to be welded and entering the first command and second command could initiate a sequence for moving the impinge point 245 to the selected location and firing the laser to make a weld without further input from an operator.

In a second mode of operation, the operator manipulates the mouse 520 to position the cursor at a first point on the displayed image as in the first mode of operation. By entering a first input command, eg pressing the left mouse button 522, the system may enter into a drag mode. In the drag mode, with the left mouse button depressed, the mouse may then be used to drag the cursor 600 to a second location, eg the crosshairs 565, in response to movement commands, eg by holding down the left mouse button 522 while moving the mouse. These inputs are processed by the processor 512, in accordance with the logic stored in the memory 514, to generate commands which result in movement of the displayed cursor 600 from the selected first point to a drag location while simultaneously moving the deflecting mirrors 320 325 such that the impinge point 245 and the camera line of sight move in unison with the cursor 600. In this case, the selected first point may be a desired location for a spot weld on the portion of the amplifier 100 being displayed, and the drag location or second point, may be the crosshairs 565. This second mode may also be used by the operation as a means panning the camera 250 to view another portions of the amplifier 100 that are outside the field of view. For example, the first point may be adjacent to one edge of the camera field of view and the drag position or second point may be adjacent to an opposite edge of the field of view so that the camera field of view is panned across the amplifier 100 for viewing other portions thereof.

Once the cursor 600 has been moved to the drag location, the operator may enter another command eg by releasing the left button 522 which stops any movement of the deflecting mirrors 320 325 and releases the cursor 600 to again be moved independently over the image by the operator. If the operator is satisfied that the drag location or second point is a desired weld location and that it has been properly positioned coincident with the crosshairs 565, a fire command may be entered. Otherwise, further dragging of the impinge point may be performed to select a different weld position before firing the weld beam.

That is, according to the present invention, the operator may identify a weld location by viewing the output of a coaxial camera 250 displayed on a monitor 560, while the amplifier 100 is supported by a table support 150, and enter movement commands which result in a cursor 600 or other point identifier being moved over the camera image without a change in the image being displayed and without the laser impinge point 245 being moved. Only after the initial cursor movement to a desired first point location, will a further operator command result in the galvo's 335 and 340 being commanded to drive the movement of the deflectors 320 and 325 until the weld location is displayed so as to be exactly aligned with the displayed crosshairs 565. The clicking of the button in the first mode or release of the button in the second mode may also be processed by the processor 512, in accordance with the stored logic, to fire the laser to make the weld as soon as the deflecting mirrors 320 325 are in position. Alternately, a plurality of weld locations 140 can be selected by an operator and stored at the memory 514 as will be discussed further below.

FIGS. 6A, 6B and 6C depict images displayed on the display monitor 560 both before, during and after manipulation of the mouse 520 by the operator to align the weld impinge point 245 represented by the fixed crosshairs 565 with one or more points on the amplifier 100 to be spot welded.

As shown in FIG. 6A, the originally displayed image of a portion of the amplifier 100, shown completely in FIG. 1, includes a point on the hypotube 120 centered at the crosshairs 565 of the displayed image. The cursor 600 and crosshairs 565 are displayed superimposed on the displayed image, or the crosshairs 556 may be otherwise marked on the display. In this particular example, the operator wishes to locate a spot weld on the upper right side of the tab 130, as shown in FIG. 1. Accordingly, the operator manipulates the mouse 520 to move the cursor 600 without changing the field of view of the camera 250 with respect to the amplifier 100, and hence without changing the image displayed on the monitor 560.

As shown in FIG. 6B the cursor 600 has been moved to the desired location of a spot-weld which is referred to as a first point above. The user then enters a first command which stores the—location of the first point in a memory 514 and which may initiate the movement of the deflecting mirrors 320 325 to direct the laser beam to impinge on the amplifier 100 at the first point which the operator has selected and as indicated by the position of the cursor 600. Once the deflecting mirror movement is complete, the first point will be displayed coincident with the crosshairs 565 as shown in FIG. 6C and a new image will be displayed on the display device. In the first mode of operation, the operator need only click on the first button, eg right button 524, to enter a move command. In the second mode of operation, the operator moves the cursor 600 to select a location for placing a spot weld and then enters a first command eg by pressing and holding down the left mouse button 522, to initiate the drag mode. Once in drag mode, the operator then drags the mouse 520 to position the cursor 600, which in turn actively drags the deflecting mirrors 320 326 until the first point is positioned at a second point or drag location. In general, the second point will be the crosshairs 565 as depicted in FIG. 6C. The release of the left button 522 provides a second command for exiting the drag mode and stopping movement of the reflecting mirrors 320 325.

In accordance with the first command initiating the drag mode, the processor 512 will automatically issue commands to the galvo's to move the deflecting mirrors 320 325, and thereby change the field of view so that the image line of sight and the impinge point 245, in response to movement inputs by the operator, are aligned with the crosshairs 565 as depicted in FIG. 6C. It will be understood that when operating in the second or drag mode, a continuously changing image will be displayed on the monitor 560 as the camera line of sight is being dragged with the cursor 600 to the crosshairs 565, ie. from an operator selected position shown in FIG. 6B to a final drag position shown in FIG. 6C. Accordingly, the present invention allows an operator to easily align the laser beam with the desired location on a work piece surface 102 while viewing a displayed image of the work piece. Furthermore, the use of an independent point indicator, such as a cursor, to identify the laser beam impinge location with respect to the work piece 100 on the device and a processor to automatically control the multi-directional movement of various elements, which is often required to align the impinge point on an image of a device with the crosshairs of the display monitor, is easy for even those operators who are not accustomed to manipulating a mouse to change a displayed image.

Using the present invention, the operators' only task is to manipulate a mouse to move a cursor over a fixed image of the work piece and to identify a desired location on the work piece for laser processing. Further, even when the image of the work piece is changing due to the movement of the mouse, during location dragging in the second mode of operation, the dragging of the desired location to another location on the display device is easily controlled by the operator on the continually changing displayed image, making it a rather simple task to accurately align the desired location with the displayed cross hairs. That is, even in this later case, the operator is given a specific pre-indication of how the manipulations of the mouse will affect what is displayed and where the new laser impinge point will be positioned on the work piece. Accordingly, the present invention significantly improves the ease at which an operator can manipulate a laser impinge point with respect to the work piece and a displayed image of the work piece, even for those operators unaccustomed to manipulating a mouse.

As mentioned above, multiple weld point locations 245 can be individually identified and stored as a pattern of welds. For example, the locations for spot welds on tabs 125 and 130 and on saddle 145, as shown in FIG. 1, could be individually identified as discussed above and stored as one or more patterns of welds at memory 514 by the processor 512. To do so, an operator may initiate a mode of operation whereby; several weld points may be identified on a fixed image by positioning the cursor 600 over each point in the image that a weld should be placed. To select each weld point the operator first provides movement inputs to position the cursor to a desired weld point and then provides a first command that stores the selected point in memory with no further action. Once all of the selected points are stored, the operator may enter commands for identifying the selected points as a weld pattern and the pattern may be stored for recall by the operator for welding the next device to be welded. In a further aspect of storing weld patterns, the operator may then pan the camera field of view to other portions of the work surface, eg to tab 125 or bridge 145 and tube 120 to store addition weld locations in memory. In addition, the work surface 102 may not be planar, as is the present case, such that each weld location may include three spatial coordinates such as an X and Y coordinate location on the work surface 102 substantially perpendicular to the laser processing beam impinge direction and a Z coordinate eg with respect to the processing beam focal point or other Z axis reference. Accordingly, the system is capable of storing three coordinates for positioning the impinge point 245 with respect to a work piece.

According to another aspect of the present invention, the processor 512, in accordance with the logic stored at memory 514, may direct a continuing display of selected weld locations identified by the operator. According to this embodiment, several weld points, eg a weld pattern, may be selected by the operator without changing the displayed image and while each weld point in the pattern is identified by continuously displaying a marker over the selected points. As shown in FIG. 6C, location 245 as well as the four other previously identified locations for weld points 140 on tab 130 are depicted simultaneously. It should be noted that the four previously identified locations are depicted as empty circles displayed over the image of the work piece, while location 245 which is coincident with the laser impinge point, is depicted as a solid circle displayed over the work piece image, to provide the operator with a clear indication of identified and yet to be identified locations. Rather than distinguishing these locations using solid and empty circles, a variation in color could be used. Accordingly, using the present invention an operator may quickly identify a plurality of weld locations on a work piece by moving a cursor over a fixed image of the work piece and entering a command to select each of a plurality of desired weld locations. Moreover, each weld location may be stored in memory, displayed over the image and the position of each weld location may be stored as a weld pattern in a memory 514.

As shown in FIG. 7, a plurality of points 140 have been selected by an operator and displayed over the image. To indicate that the points 140 are a pattern, a stop location may be entered. The stop location provides a point where the laser impinge point 245 will be positioned when the weld pattern is completed. In the present embodiment, the cursor 600 has been moved to location 700 away from the weld pattern on the right side of tab 130. The operator may enter another command to identify location 700 as a stop point for positioning the laser impinge points 245 when the weld pattern is completed. For example, the operator may simply double click on the first button, eg button 522, to enter the other command. Upon receiving the stop command, the processor 512 may store each of the weld locations 140 as a pattern and also store the stop location as part of the pattern. Alternately, the last weld in the pattern maybe used as a stop point.

If a pattern is stored, the operator need only initiate the job by identifying the pattern and the processor 514 will retrieve the pattern from the memory 514 and process the location data therein to generate the necessary commands to the display monitor 560 and the galvo's 335 and 340. Based on these commands, each identified location, eg the identified location of a weld point, which forms a part of a pattern, is displayed over the image of the amplifier 100. At this time an operator may inspect the pattern of welds and decide if the pattern meets the requirements of the job and if so initiate a weld sequence. Accordingly, the processor 512 may initiate welding each of the welds in the pattern under automatic control and then position the laser impinge point 245 in the stop position and wait for further operator commands. The weld pattern may be displayed during the welding. Advantageously, all the weld locations in the pattern are also simultaneously displayed continuously in a portion of the screen, so that locations at which welds have been previously made as well as locations at which welds will subsequently be made are displayed. Locations at which welds have previously been made may be identified by empty circles or a particular color indicator, while locations at which welds will subsequently be made may be identified by solid circles or a different color, thereby providing the operator with a clear indication of the identified locations at which welds have been made and the identified locations at which welds have not been made.

In a further embodiment, multiple patterns maybe joined together and stored as a single pattern in the memory 514. In this example, a first pattern maybe stored as described above, eg for welding the tab 130 shown in FIG. 7. Once the first pattern is stored in memory, the operator may pan to other portions of the amplifier 100, eg the tab 125, the bridge 145 and the tube 120 and select further weld locations and save those location as second third and fourth weld patterns, each separately identified. Upon completing all of the patterns, the operator may enter commands to group the patterns and to automatically perform each pattern of welds and various panning motions of the camera field of view and laser processing beam to direct the reflecting mirrors 320 325 to a location for welding each individual patterns. This mode may also include stops, which would stop the welding at desired locations to allow the operator to inspect the pattern and make changes as required.

Responsive to the commands from the processor 512, the galvo's 335 and 340 drive the deflectors 320 and 325 to direct the light beam 207 emitted from the fiber optic 205 to form the spot welds on the tabs 125 and 130 and spot welds on the saddle 145 at the stored locations. If the pattern includes the above described stop location, the processor 512 will automatically generate commands for displaying the stop location, for example using a still further color for the stop location, and for stopping the movement of the galvo's after the spot weld 140 is formed at location 245 and before the adjacent spot weld 140 on the right side of tab 130 is made. If, for example, the operator wishes to adjust the location of the adjacent weld, perhaps due to an edge flaw in tab 130, the operator can use the mouse to modify the location of the adjacent weld as discussed above, during the welding job or prior to initiating the welding job. For example, the operator might manipulate the mouse to jog just one of the weld locations in a pattern with the cursor to relocate the weld position before entering a further input to initiate or continue the job. If no adjustment is required, the operator can simply enter a further input to continue the job and the spot welds will be made at the originally stored location.

According to another aspect of the invention, the operator can move the cursor 600 to location 700 of FIG. 7 during a job and enter another input to identify location 700 as a stop point between the weld point location 245 and an adjacent weld point location for a weld 140 on the right side of tab 130. Here again, the operator may, for example, simply double click on the first button, eg button 522, to enter the stop input. In this case, the processor 512 can either store the stop location as part of a stored pattern or temporarily store the stop location until the stop has been executed. Logic can be stored in the memory to offer the operator the ability to select which storage option is desired.

The control subsystem 500 is calibrated by matching the distance moved over the work piece, eg amplifier 100, with the movement of the cursor 600 on screen. Calibration can be performed by entering user inputs using the mouse 520 or some other type input device as is well understood by those skilled in the art. To begin calibration, the galvo's are centered within the range of each galovs' rotation by entering a user command. A test piece, such an exemplary amplifier 100 is loaded on the support table 150 so as to be displayed on the monitor 560. Alternately, a target pattern having features of known dimensions may be used as a test piece to correlate movement of the cursor as viewed on the display device with the physical dimensions of the target pattern. A suitable target within the viewing area is identified by moving the mouse 520 to direct the cursor 600 to the target. A user command to direct initiation of pixel measurement is entered.

Next, the mouse 520 is again moved to relocate the cursor 600 onto the image and to the top point of the feature within the image being measured or used as a reference. One of the first or second mouse buttons 522 or 524 is clicked to select this point as the start point for the measurement. The processor 512, in accordance with the logic stored at memory 514, determines if the next movement of the mouse 520 is in the direction of the X or Y-axis and sets the correct computation corresponding to the direction of movement. The mouse 520 is again moved to relocate the cursor 600 on the displayed image to other end of the feature being used as the reference and one of the mouse buttons 522 or 524 is clicked to record the number of pixels moved on screen. The mouse 520 is once again moved to relocate the cursor 600 back to the start point and one of the mouse buttons 522 or 524 is pressed and held to drag the start point to the center crosshair on the displayed image. The button is then released.

Another command is entered to start galvo measurement. The mouse 520 is then moved to relocate the cursor 600 into the field of view of the displayed image and one of the mouse buttons 522 or 524 is pressed to indicate a drag point. The mouse 520 is moved again to drag the drag point to the crosshair 565 on display monitor 560. The button is then released.

With the drag point correctly positioned, a further user command directs the processor 512 to calculate, in accordance with the logic stored in memory 514, the Y or X-axis conversion value, as applicable. The processor 512 then directs a display of the conversion value on the display monitor 560. The process is repeated for the other axis.

Once calibration has been completed, the processor 512, in accordance with logic stored on the memory 514, determines the X and Y cursor movement distances, and calculates the distance to the center of the display, eg to the crosshairs 565. The processor 512 then converts the determined distances into galvo's increments using the conversion values generated during the calibration.

To command the galvo's in the first mode of operation, the processor 512, in accordance with the logic stored at the memory 514, determines the X and Y cursor movement distances, calculates the distance to the center of the display, and converts the determined distances into galvo angle increments using the conversion values generated during the calibration, as discussed above. However, in this mode, the processor 512 also parses the commands for the required number of galvo increments. This allows the galvo's to direct the processing beam at the identified point, eg a weld point or first location to the desired position, without the need to drag the identified point on the displayed image. This may, in some implementations significantly increase the speed and ease of use.

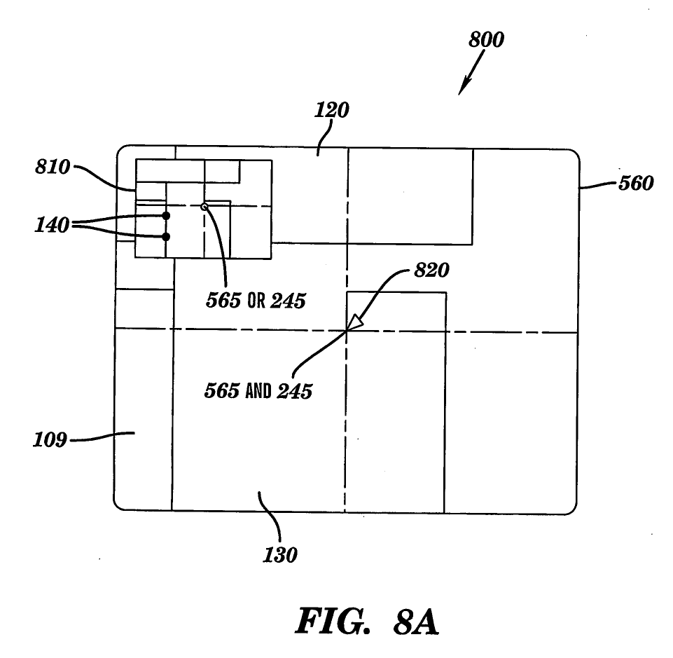

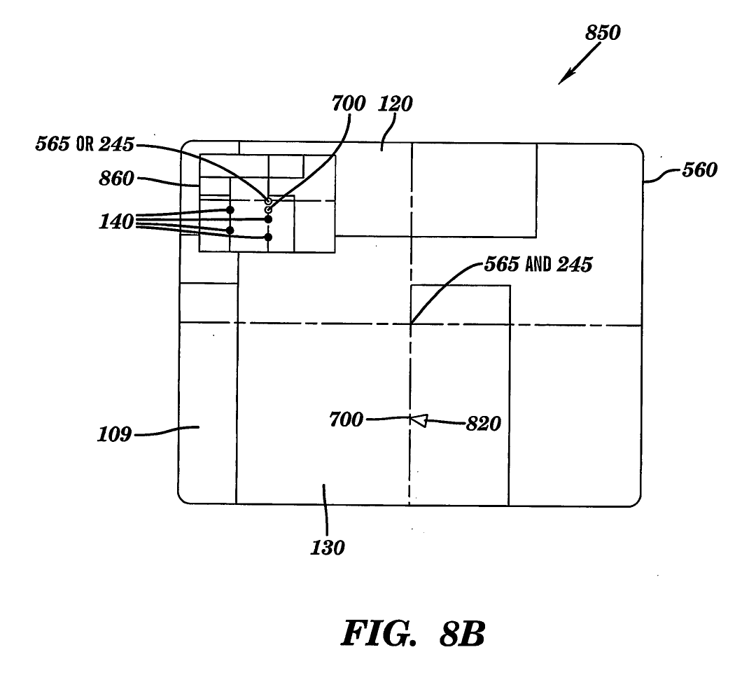

FIGS. 8A and 8B depict a particularly advantageous display interfaces 800 and 850 for presenting images on the display monitor 560. The interface is implemented by commands issued to the display monitor 560 by the processor 512, in accordance with the logic stored at memory 514, in the case of FIG. 8A, while a pattern of weld points is being identified and, in the case of FIG. 8B, during welding operations.

As shown in FIG. 8A, during operations to identify a pattern of welds, the operator has moved the cursor 820 to the desired location and entered a command to align the laser impinge point 245 with a desired weld point. As previously described, in accordance with the command, the processor 512 has automatically issued commands to the galvo's to move the deflecting mirrors 320 325, and thereby change the field of view so that the image displayed has the desired weld location aligned with the crosshairs 565 as depicted in FIG. 8A.

As shown, the primary display area of monitor displays only a small portion of the amplifier 100 in the vicinity of the desired weld point 245, including a portion of the left tab 130, pad 109 and hypo tube 120. A thumbnail display area 810 of the monitor 560 displays a larger portion of the amplifier 100 in the vicinity of the desired weld point 245, including not only a greater portion of the left tab 130, pad 109 and hypo tube 120, but also other previously defined and stored locations for spot welds 140 on tab 130. Accordingly, the interface 800 provides a continuing display of previously identified and stored locations, of weld points forming a part of a pattern, while one or more other weld points locations are being identified. In the exemplary thumbnail display portion 810, shown in FIG. 8A, location 245 as well as the two other previously identified locations for weld points 140 on tab 130 are depicted. As has been discussed above, although the two previously identified locations are shown as solid circles and location 245 is depicted as an empty circle in the thumbnail display, other attributes could be used to differentiate between previously identified and stored pattern locations and a yet to be identified and/or stored location.

As shown in FIG. 8B, during welding operations to form a pattern of welds, the processor 512 automatically issues commands to the galvo's to move the deflecting mirrors 320 325, and thereby change the field of view so that the image displayed has the previously defined pattern weld point location at, aligned with the crosshairs 565. The primary display area of the monitor displays only a small portion of the amplifier 100 in the vicinity of the laser impinge point 245, including a portion of the left tab 130, pad 109 and hypo tube 120. A thumbnail display area 860 displays a larger portion of the amplifier 100 in the vicinity of the weld point 245, including not only a greater portion of the left tab 130, pad 109 and hypo tube 120, but also other weld points indicated as spot welds 140 on tab 130. Accordingly, the interface 850 provides a continuing display of the locations of all the weld points forming the pattern during welding operations.

In the exemplary thumb nail display 860, shown in FIG. 8B, impinge point 245 as well as the four other pattern weld points 140 on tab 130 and a pre-defined stop location 700 are depicted. Two of the weld point locations at which welds have already been formed are shown as solid circles and while the laser impinge point 245, as well as the two other weld point locations at which welds have yet to be formed are depicted as a empty circles. Stop location 700 is shown as an empty square, since the stop has not, as yet been executed. Upon execution, the displayed stop location identifier will automatically be modified, in accordance with commands issued by processor 512, to display a solid square in the thumbnail display 860. As discussed above, other attributes could be used to differentiate between executed and unexecuted stop locations if so desired.

As shown also in FIG. 8B, if the stop location 700 had not been previously defined during pattern identification operations, the operator could identify the stop location during welding operations. More particularly, during welding operations the operator can move the cursor 820 to location 830 between the next weld point and an adjacent weld point location for a weld 140 on the right side of tab 130 and enter another command to identity location 830 as a stop point between the previously identified and stored pattern weld point locations and an adjacent pattern weld point location for the weld 140 on the right side of tab 130. For example, the operator may simply double click on the first button, eg button 522, to enter the other command. Based on this command, the processor 512, in accordance with the stored logic, may either store the stop location as part of a stored pattern, or simply temporarily store the stop location. Whether stored more permanently with the pattern or only temporarily, the processor will execute the stop prior to forming the adjacent weld on the work piece subject to welding operations at the time the stop command is enter. However, if the stop command is stored as part of the pattern, the processor will execute the stop prior to forming the adjacent weld on the work piece subject to welding operations at the time the stop command is enter, as well as all work pieces subsequently subject to welding operations in accordance with the stored pattern.

It will be recognized that the thumbnail display can be easily implemented using well know techniques. For example, during operations to identify the pattern, identified and stored pattern locations and the current crosshair location can be processed by the processor 512 to generate the thumbnail display for showing the various display markers at the stored coordinates. In addition, an image of the amplifier 100, eg a computer aided design (CAD) image may be stored in the computer 510 and displayed as a thumb nail image with the generated weld identifier marks displayed over the amplifier image. Alternately, the system may be configured with a second lower magnification video camera, (not shown), for providing a second lower resolution of a larger portion of the amplifier 100 and the video signal from the second camera may be fed to the display device for displaying a large portion of or the entire work piece. Alternately, the camera 250 maybe used to pan the entire amplifier 100 and save an image of each portion in memory and an image processor may be used to tile each image together for forming the thumb nail images 810 and 860 from digital image data. During operations the processor 512 may use various stored data and logic steps to display the thumb nail images 810 and 860 which may display all or part of the work surface, previously identified weld patterns and stops, the prior weld firing locations, the yet to be welded location and the current crosshair locations.

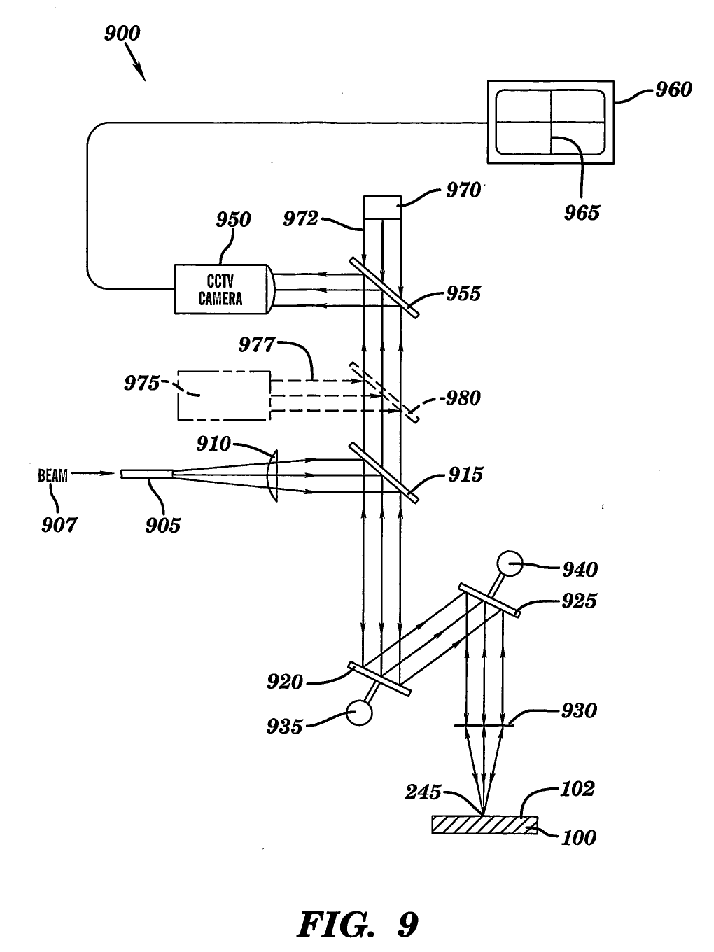

According to the present invention, an alignment aid may also be provided during both pattern definition and welding operations. As shown in FIG. 9, a laser spot welding beam delivery subsystem 900 could be used to form spot welds, such as those described above for connecting the tabs 125 and 130 to the pads 107 and 109 of the base 105. As shown, the laser spot welding beam delivery subsystem 900 includes a laser beam source, shown as fiber optic 905, which emits a laser beam 907. The beam 907 is directed by the lens 910, to a mirror 915, which deflects the beam onto first and second movable deflectors 920 and 925, which typically serve as an x-direction deflector and y-direction deflector. The beam is directed by deflectors 920 and 925 through a focus lens 930 and onto the amplifier 100 to form a desired spot weld, eg spot weld 140, at the desired location 245. The deflectors 920 and 925 are respectively driven by galvo's 935 and 940, in accordance with control signals issued by processor 512.

A closed circuit television (CCTV) camera 950, co-axially aligned with the beam 907 is also provided. The camera 950 detects light reflected from the amplifier 100 and deflected by the deflectors 920 and 925, and a mirror 955 onto a sensor (not shown) within the camera 950. An image of the entire, or more typically only a portion of the amplifier 100, is generated by the camera 950 from the detected light and displayed on a display monitor 960, which may or may not include crosshairs 965. The monitor 960 presents the image to the operator for viewing.

During operations, the processor 512 issues commands, based on user inputs or the pre-defined pattern, move the galvo's 935 and 940, which, based on the received commands, move the deflectors 920 and 925 such that a laser spot welding beam 907 emitted from the fiber optic 905 will impinge upon the amplifier 100 at a desired location, eg location 245. That is, during operations to define the pattern, the operator identifies each weld location, eg weld location 245, by moving the mouse 520 as described in detail above, while viewing the output of a coaxial camera 950 displayed on a monitor 960, to align the desired impinge location, eg location 245 on the amplifier 100 with a beam 907 emitted from the fiber optic 905. During welding operations, the processor 512 identifies each weld location, by retrieving the pattern weld locations from storage, as described in detail above. During welding operations, the operator can also view the output of a coaxial camera 950 displayed on a monitor 960, to observe the alignment of the desired location, eg location 245 on the amplifier 100 with a beam 907 emitted from the fiber optic 905.

Advantageously, the laser spot welding beam delivery subsystem 900 also includes a coaxially aligned visible laser eg a HeNe laser or red diode laser, beam source 970 with partially transmitting mirror 955 or, alternatively, a HeNe laser or red diode colored beam source 975 and partially transmitting mirror 980. As shown, the visible beam source 970 is aligned such that it emits a beam directly onto a first deflecting mirror 920. The visible beam source 975 is aligned such that it emits a beam onto partially transmitting mirror 980. The mirror 980 in turn reflects the beam onto first deflecting mirror 920. As will be understood, in either configuration the visible beam emitted by source 970 or 975 is directed so as to be coaxial with the processing laser beam 907 emitted by fiber optic 905 and to identify the impinge point thereof.

During pattern identification operations, the processor 512 issues commands, based on user inputs, to move the galvo's 935 and 940, which, in turn move the deflectors 920 and 925 such that a visible beam 972 or 977 emitted from the visible beam source 970 or 975 will impinge upon the amplifier 100 at a location identified by the operator inputs. The processor 512 may direct that the visible beam source 970 or 975 to emit the visible beam either continuously, or responsive to a user command to assist the operator in dragging or otherwise moving the laser impinge point 245 to a desired weld location which in the present embodiment is identified by the position of the visible laser beam spot as view in the monitor 960. The reflection of the visible beam will be detected by the coaxial camera 950 and the output of a coaxial camera 950, including a visible spot, eg a red dot, at the laser impinge point 245, is displayed on the monitor 960. The display of the visible spot on both the amplifier 100 and the display monitor 960 can serve as a substantial aid to the operator in confirming the proper alignment of the desired location on the amplifier 100 with the beam impinge point 245, prior to storing the location as a pattern location.

During pattern welding operations, the processor 512 issues commands to the visible beam source 970 or 975 to emit the visible beam 972 or 977, and to the galvo's 935 and 940 to move the deflecting mirrors 920 and 925, based on the identified pattern. The directed movement of the galvo's 935 and 940, along with the emission of the visible beam 972 or 977 by the applicable source 970 or 975, cause the visible beam 972 or 977 emitted from the visible beam source 970 or 975 to impinge upon the amplifier 100 at a location identified by the pattern. The reflection of the emitted visible beam is detected by the coaxial camera 950 and the output of a coaxial camera 950, including a visible spot, eg a red dot, at the identified location, eg location 245, is displayed on the monitor 960. Here again, the display of the visible spot on both the amplifier 100 and the display monitor 960 can serve as a substantial aid to the operator in confirming the proper alignment of the pattern location, eg location 245, on the amplifier 100 with a beam 907, prior to forming a weld at the location. For example, after a new work piece 100 is positioned onto the support table 150, the processor 512 directs the galvo's to immediately position the deflecting mirrors to view one of the pattern locations. An operator viewing the display monitor can readily determine if a red dot on the screen appears to be out of alignment and can quickly click on the mouse to halt welding operations before welding at the location proceeds. The operator can then use the mouse to adjust the location of the laser impinge point 245 by clicking on the red dot and moving it before proceeding with welding operations.

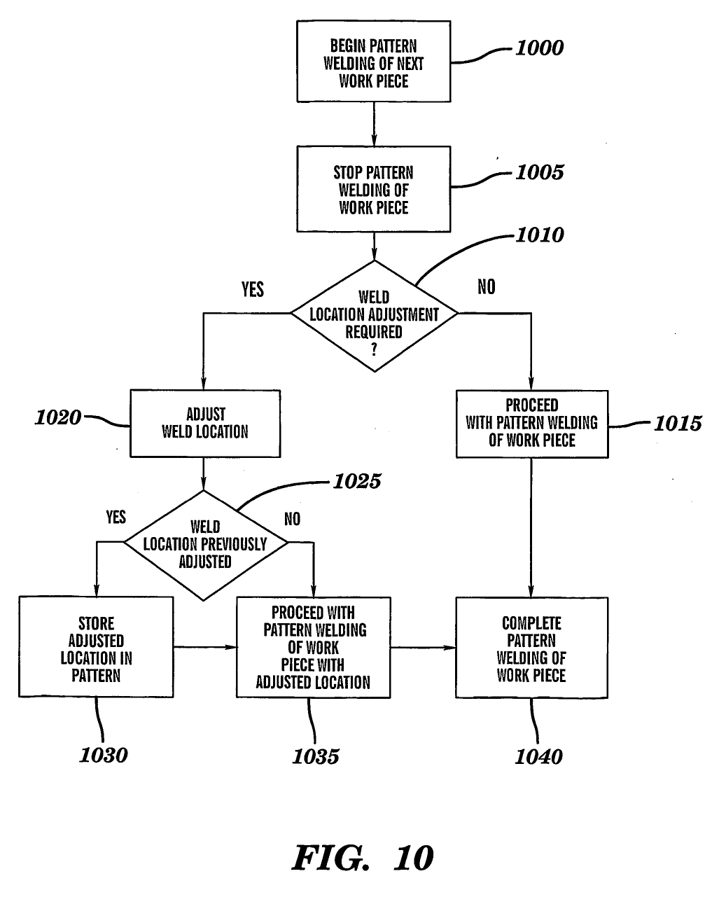

FIG. 10 depicts a flowchart of the steps performed by the processor 512, based on the logic stored at memory 514, to retrain a laser spot welding beam delivery subsystem such as subsystem 900. The processor 512 initiates welding of a work piece in accordance with a pattern retrieved from the memory 514 in step 1000. The pattern welding is halted in step 1005. This stop in the pattern welding could be based on a stop command stored as part of the pattern or a stop command entered by the user during welding operations, as has been detailed above.

With the welding operations halted, a determination is made in step 1010, for example by the operator, as to whether or not the next weld location displayed at the crosshairs of the display monitor 560 requires adjustment. If not, the pattern welding of the work piece proceeds in step 1015.

However, if a determination is made that an adjustment is required, the adjustment is made in step 1020. For example, the operator may wish to realign the displayed portion of the work piece with the crosshairs due to a defect in a work piece. Such an adjustment might be made by jogging the location using the mouse 520, as has been described above.

In step 1025, the processor determines if the weld location has been previously adjusted. For example, the processor 512 may store a flag or other indicator of each adjustment to each weld in the weld pattern. This information can be used to determine if the adjustment made in step 1020 is identical to an adjustment made to the same weld location on the immediately preceding work piece welded prior to the work piece currently being welded. If so, the processor 512 modifies the pattern to substitute the adjusted location for the stored location in step 1030, and directs the pattern welding of the work piece to proceed with the adjusted location in Step 1035. If not, the previously stored pattern is retained as is, and the pattern welding proceeds at the adjusted location on only the current work piece. Pattern welding continues until completion of the welding of the work piece in Step 1040. The steps are repeated for each additional work piece in the job.

It may be beneficial in certain implementations to form two or more welds at the same time. For example, by simultaneously forming multiple welds, the welds can be made to evenly pull down on a component. An operator may also benefit from forming top and bottom welds simultaneously for reasons, which will be recognized by those skilled in the art.

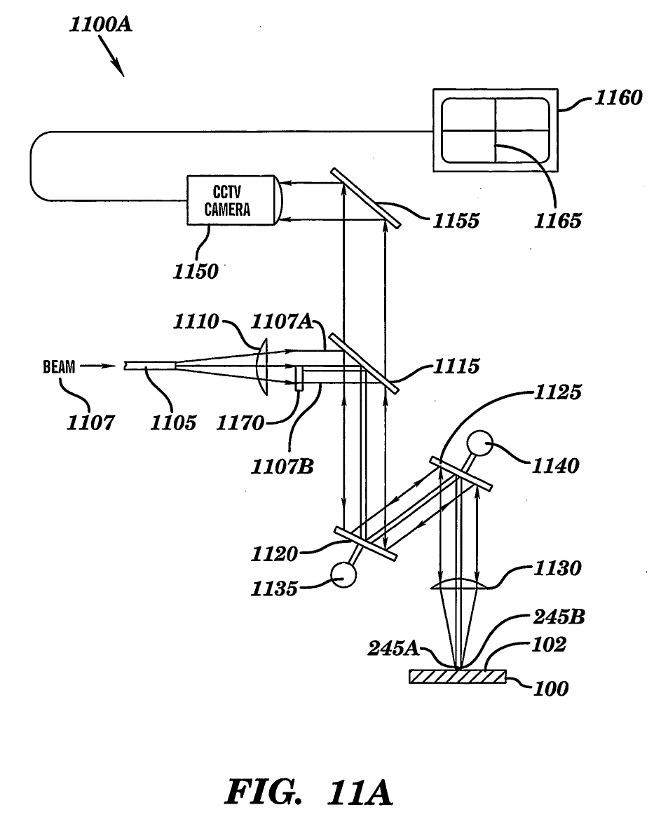

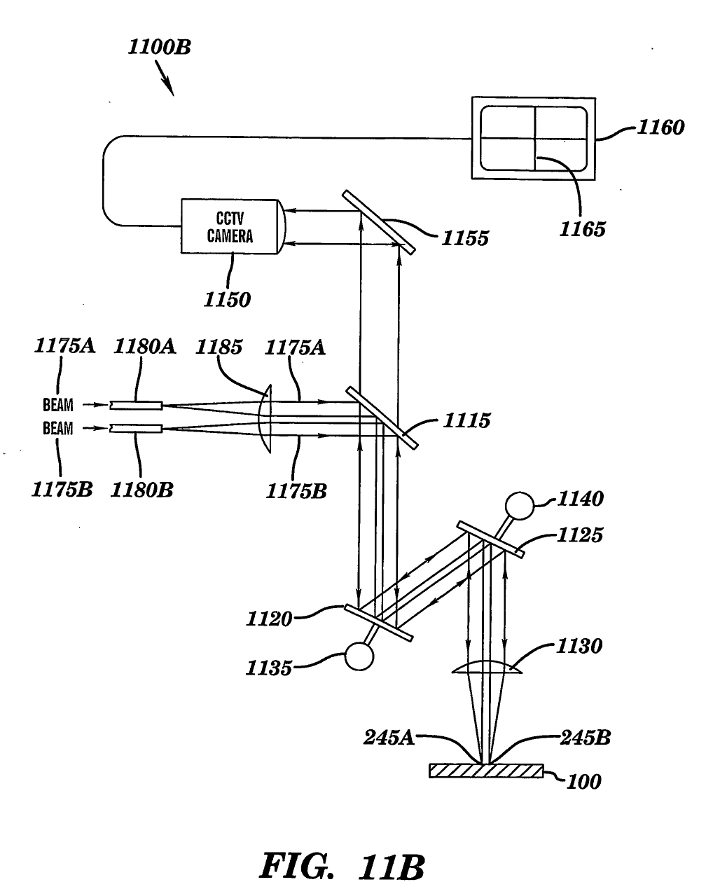

FIGS. 11A and 11B depict exemplary embodiments of dual beam laser spot welding beam delivery subsystems 1100A and 1100B in accordance with the present invention. It will be understood that the dual beam laser spot welding beam delivery subsystems depicted in FIGS. 11A and 11B are easily adaptable to accommodate any number of multiple beams. Accordingly, if desired the depicted subsystems can be easily modified to provide a three, four, or more multiple beams which simultaneously impinge upon a work piece.

As shown in FIGS. 11A and 11B, the laser spot welding beam delivery subsystems 1100A and 1100B, can be controlled by the processor 512 to simultaneously form dual spot welds, such as those described above for connecting the tabs 125 and 130 to the pads 107 and 109 of the base 105. As shown, each of the laser spot welding beam delivery subsystems 1100A and 1100B include a mirror 1115 which deflects the dual beams onto first and second movable deflecting mirrors 1120 and 1125, which typically serve as an x-direction deflector and y-direction deflector. The beams are directed by deflectors 1120 and 1125 through a focus lens 1130 and onto the amplifier 100 to form a desired spot welds, eg spot welds 140, at the impinge locations 245A and 245B. The deflectors 1120 and 1125 are respectively driven by galvo's 1135 and 1140, in accordance with control signals issued by processor 512.

A closed circuit television (CCTV) camera 1150, co-axially aligned with the beams is also provided. The camera 1150 detects light reflected from the amplifier 100 and deflected by the deflectors 1120 and 1125, and a mirror 1155 onto a sensor (not shown) within the camera 1150. An image of the entire, or more typically only a portion of the amplifier 100, is generated by the camera 1150 from the detected light and displayed on a display monitor 1160, having crosshairs 1165 or other impinge point identifying means. The monitor 1160 presents the image to the operator for viewing.

As shown in FIG. 11A, the dual beam laser spot welding beam delivery subsystem 100A includes a fiber optic 1105 which directs abeam 1107 through a lens 1110. After passing through the lens 1110 the beam is spilt by beam splitter 1170 into fixed separation dual beams 1107A and 1107B. These beams are then reflected by partially reflective mirror 1115 onto deflector 1120. The beam splitter 1170 could include a prism, and/or other devices to split the beam 1107 into dual beams 1107A and 1107B. The prism could be fixed at a location within the beam path so that the subsystem 1100A only operates in a dual beam mode. Alternatively, the beam splitter could, if desired, include a removable prism, eg a prism mounted on a slide, which is moveable in and out of the beam path, in accordance with control signals from the processor 512. If a removable prism is included, the system can be selectively operated in either a single spot welding mode or dual spot welding mode. The flexibility provided by such a dual operating mode subsystem may be particularly advantageous in certain implementations.

As shown in FIG. 11B, the dual beam laser spot welding beam delivery subsystem 1100B includes two fiber optics 1180A and 1180B which direct fixed separation dual beams 1175A and 1175B through lens 1185 and onto mirror 1115. The mirror 1115 onto deflector 1120 reflects the dual beams 1175A and 1175B. Here again, subsystem 1100A may operate in a single or a dual beam mode by providing a processor controlled beam modulation. As a still further alternative, in subsystem 100B the beam 1175A and 1175B generator(s) (not shown) may be controlled by the processor 512 such that, in a first mode of operation, only one of the beams is generated while, in a second mode of operation, both of the beams are generated. The flexibility provided by such a dual operating mode subsystem may be particularly advantageous in certain implementations.

It should be noted that, if desired, the beam splitter 1170 could be configured to split beam 1107 into dual beams having a selectable, rather than fixed, separation. For example, in the subsystem 1100A, the beam splitter 1170 could include one or more prisms that can be rotated to vary the spatial separation of the dual beams. In the case of the subsystem 1100B, the separation between the fiber optics 1180A and 1180B could if desired be made variable using well known techniques to vary the separation between the beams 1175A and 1175B. In either case, the processor 512 is easily adaptable to include the logic necessary to allow selection of the desired beam separation distance and to generate commands to the beam splitter 1170 or fiber optic separator (not shown) based on the selected separation. Alternatively either subsystem 1100A or 1100B could include an inclined mirror, which is effectively a two-piece mirror with a hinge. The processor 512 is also easily adapted to include the logic necessary to change the angle between the pieces at the hinge to change the separation between the dual beams to a selected separation distance.

During operations the processor 512 issues commands, based on user inputs or the pre-defined pattern, to move the galvo's 1135 and 1140, which, based on the received commands, move the deflectors 1120 and 1125 such that the dual laser spot welding beams 1107A and 1107B or 1175A and 1175B impinge upon the amplifier 100 at desired locations, eg location 245A and 245B. That is, during operations to define the pattern, the operator identifies one or more impinge points 245A and 245B for each pair of weld beams by moving the mouse 520 as described in detail above, while viewing the output of a coaxial camera 1150 displayed on a monitor 1160, to align the impinge points 245A and 245B, with selected weld locations on the amplifier 100. It should be understood that although on one set of crosshairs 1165 are depicted, dual crosshairs could be displayed if so desired. During welding operations, the processor 512 retrieves each pair of weld locations, by retrieving the pattern weld locations from storage, as described in detail above. During welding operations, the operator can also view the output of the coaxial camera 1150 displayed on a monitor 1160, to observe the alignment of the desired locations, eg locations 245A and 245B on the amplifier 100 with a beams 1107A and 1107B or 1175A and 1175B.

To obtain high quality welds, it is important that the process beam be focused at the weld location. Accordingly, high quality welding requires that the focus of the beam, ie. the impinge point 245, correspond to the height of the surface of the work piece 100 to be welded or processed. This is commonly referred to as the z-axis position of the impinge point 245.

For example, if the welds on the above described saddle 145 and pads 107 and 108 are at different heights, the z-axis position of the welding beam impinge point 245 should be different when forming a weld on the saddle and forming a weld on the pads, if high quality welds are to be formed on both the saddle and pad. Accordingly, adjustments to the z-axis position of the impinge point 245 or of the position of the surface of the work piece 100 will be required. Further, even if the saddle and pads were manufactured to the same nominal height, in practice there may be slight defects in some or even many of the saddles and/or pads, which result in variations in height from saddle-to-saddle and/or pad-to-pad. Here again, to maintain quality, the z-axis position of the impinge point or the work piece may be adjusted to account for these variations from the nominal height.

Typically, the operator considers the beam to be properly focused if the image presented to the operator on the display monitor is reasonably within focus, since the camera and process beam are co-axially aligned and coincidentally focused at a common Z-axis focal point. Conventionally, if it is determined that an adjustment in the focus of the camera image is required, the operator adjusts the height of the work piece by adjusting the height of the table 150 supporting the work piece. However, this in practice results in a rather crude z-axis focus adjustment. Accordingly, a more accurate z-axis focus adjustment technique is needed.

Capacitors have been used for many years to sense the distance between a surface of a work piece and a capacitive element mounted at a distal end of the laser beam delivery system, eg between the focus lens 1130 and the work surface 100 as shown in FIG. 11B. Although sensing a distance from a work piece using capacitors is preferable over the current visual technique discussed above, capacitor based height sensing has many well-recognized deficiencies if used with small work pieces of the type described above.

More recently, optical sensors capable of sensing the position of a very small area have been developed. In a particularly advantageous embodiment of the present invention, an optical sensor is incorporated into the beam delivery subsystem to sense energy reflected from an area around each location of interest coaxial with a beam, eg a welding beam. The optical sensor and a subsystem z-axis processor can be used to adjust the z-axis position of the work piece surface with respect to the beam delivery system so as to maintain a substantially uniform distance between the beam delivery system and the work piece. Further, the z-axis processor can also utilize input from the mouse to automatically drive the support table adjustment in the z-axis simultaneous with the user directed movements of locations on an image. Accordingly, by incorporating the optical sensor, the z-axis processor and an automatic z-axis table motion device in communication with the processor a uniform focal distance between the beam delivery system and the work surface can be maintained.

Of course more course z-axis motions may also be required to weld micro-assemblies needing to be welded in one or more different parallel planes spaced apart along the z-axis. In this case, the storing of coordinates of each weld in a welding pattern may require storing an X, Y and Z coordinate.

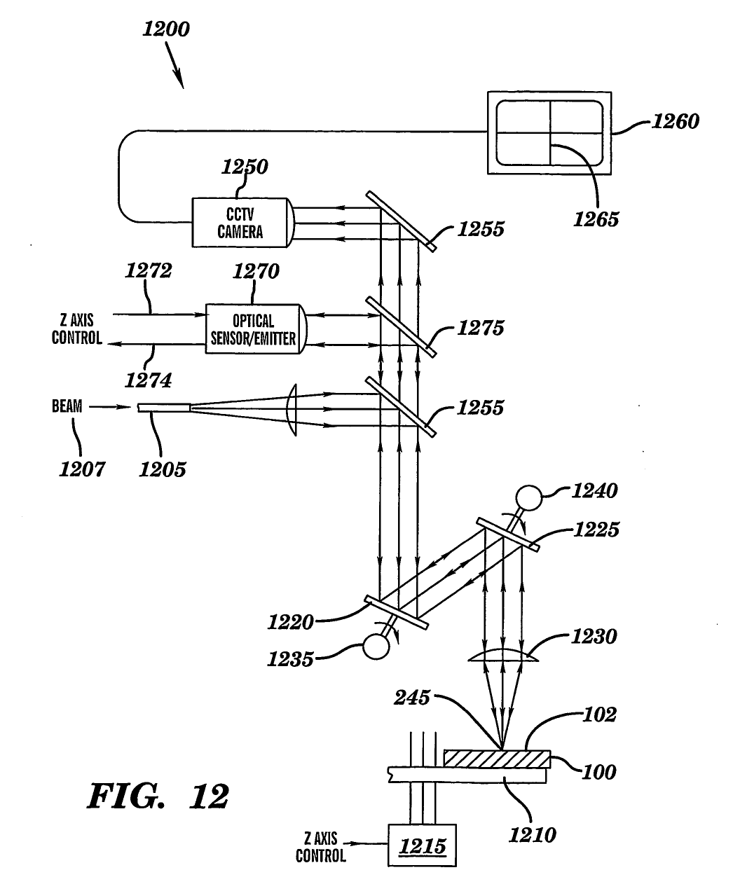

FIG. 12 depicts an exemplary beam laser spot welding beam delivery subsystem 1200 which incorporates an optical sensor to provide automated z-axis focusing positioning of the impinge point 245 with respect to the work piece 100. As shown in FIG. 12, the laser spot welding beam delivery subsystems 1200, can be controlled by the processor 512 to automatically adjust the z-axis focus of a spot weld, such as the spot welds described above for connecting the tabs 125 and 130 to the pads 107 and 109 of the base 105 by providing a drive signal to a z-axis motion device 1215 for moving the a support table 1216 supporting the amplifier 100 along the z-axis. As shown, the laser spot welding beam delivery subsystem 1200 includes a fiber optic 1205, which directs a beam 1207 through a lens 1210 onto a partially reflective mirror 1215. The mirror 1215 deflects the beam onto first and second movable deflecting mirrors 1220 and 1225, which typically serve as an x-direction deflector and y-direction deflector for moving the process beam 1207 over the work piece 100. The process beam 1207 is directed by deflectors 1220 and 1225 through a focus lens 1230 and onto the amplifier 100 to form a desired spot weld, eg spot weld 140, at the desired x-y location. The deflectors 1220 and 1225 are respectively driven by galvo's 1235 and 1240, in accordance with control signals issued by processor 512.

A closed circuit television (CCTV) camera 1250, co-axially aligned with the beam is also provided. The camera 1250 detects light reflected from the amplifier 100 and deflected by the deflectors 1220 and 1225, and a mirror 1255 onto a sensor (not shown) within the camera 1250. An image of the entire, or more typically only a portion of the amplifier 100, is generated by the camera 1250 from the detected light and displayed on a display monitor 1260, having crosshairs 1265. The monitor 1260 presents the image to the operator for viewing.

As shown in FIG. 12, the laser spot welding beam delivery subsystem 1200 includes a coaxial optical sensor/emitter 1270, which directs a focus-sensing beam 1272 onto a partially reflective Dichroic mirror 1275, prior to scanning operations using beam 1207. Ideally, the system is configured such that a focal plan of the camera 1250, the sensing focus beam 1272, and the welding beam 1207 are preferably set to be coincident at the same z-axis point or plane. However, in practice the depth of focus of the camera may vary slightly from that of the beams. The mirror 1275 deflects the focus sensing beam 1272 onto the movable deflectors 1220 and 1225, which in turn direct the focus sensing beam 1272 through the focus lens 1230 which focuses the sensing beam 1272 on the amplifier 100 at the desired location, eg location 245. As discussed above, the deflectors 1220 and 1225 are respectively driven by galvo's 1235 and 1240, in accordance with control signals issued by processor 512.

During operations, the processor 512 determines if a z-axis, adjustment, sometimes referred to as a height adjustment, of the position of the work piece 100 is required, and issues commands to direct any required z-axis focus adjustment in the following manner. The processor 512 first issues commands to the optical sensor/emitter 1270 to direct the emission of the focus sensing beam 1272 onto the work surface of the amplifier 100 at a desired x-y location. That is, during operations to define the pattern, the operator identifies a weld location, by moving the mouse 520 as described in detail above, while viewing the output of a coaxial camera 1250 displayed on a monitor 1260, to align the desired location, on the amplifier 100 with the crosshairs 1265, and hence with the focus beam 1272. The reflection of the focus beam 1272 off the work piece, eg amplifier 100, is directed back to the optical sensor/emitter 1270. A sensor (not shown) within sensor/emitter 1270 detects the reflected light from the work piece and generates a sensor output signal 1274 to the processor 512. The processor 512, in accordance with logic stored at memory 514, processes the sensor output signal 1274 to determine if the focus-sensing beam 1272 is in focus at the work piece surface to within a predefined threshold. If so, operations to either identify the weld location or to form welds in accordance with a defined weld pattern are performed If not, the processor 512, in accordance with logic stored at memory 514, generates commands to either direct the movement of the focus lens 1230 or the z-axis position of the work piece 100, or alternately the z-axis position of the entire beam delivery system, to correct the out of focus condition. In the case of the work piece location, the height is typically adjusted by directing movement of a work piece support table 1210 in the vertical direction, to thereby adjust the z-axis focus of the focus beam.

Preferably, the sensor output 1274 is continuously processed during the movement of the mouse, as well as during the movement of the focus lens, subsystem or support table, and the focus of the displayed image is adjusted on an ongoing as required basis until the processor 512 determines that the focus has been sufficiently adjusted to be within the predefined threshold. Accordingly, as the location within a displayed image is moved responsive to user inputs, and individual locations are viewed on the monitor display, adjustments are automatically made for any variation from another location height or a predefined height at the moved location, so that proper beam z-axis focus and image focus is continuously maintained.

Only after the required adjustment has been made, are operations performed to either identify and/or store the weld location (with an X, Y and Z coordinate) or to actually form a weld in accordance with a defined weld pattern. If desired, a test weld or test shot can be formed to confirm that the laser beam is correctly focused.

It should be understood that, if the z-axis adjustment is performed during pattern identification, a parameter corresponding to any required adjustment, eg a focus lens 1230 adjustment parameter or a z-axis motion of the support table 1210, is stored with each identified pattern location. Accordingly, the processor 512 commands during welding operations will direct the necessary z-axis adjustment for each location by providing a drive signal to a z-axis motion drive system 1215.

If the z-axis adjustment is performed during welding operations, a parameter corresponding to the adjustment, eg a focus lens 1230 parameter or support table height, may be stored with the location to retrain the system, for example as discussed above with reference to FIG. 10. If so, the processor 512 commands during welding operations on later welded work pieces will direct the necessary z-axis adjustment for each location.

For example may require that one or more welds or weld patterns be placed at different work surfaces having different heights along the z-axis. In this case an operator may manually control the height of the work piece for moving different work surfaces into a focal plane of the processing beam. In one example, an operator may teach or program the z-axis adjustment device 1215 to move the work piece to various z-axis positions so that welds can be made on different levels and the z-axis location of each weld may be stored in the weld patterns saved by the operator. This step can be performed without automatic focus control by the focus-sensing beam 1272 by the operator moving the work surface until the camera 250 image is focus. Alternately, once the operator has roughly positioned the work piece along the z-axis, the automatic laser focus control can be used to further refine the z-axis position of the work piece as described above.

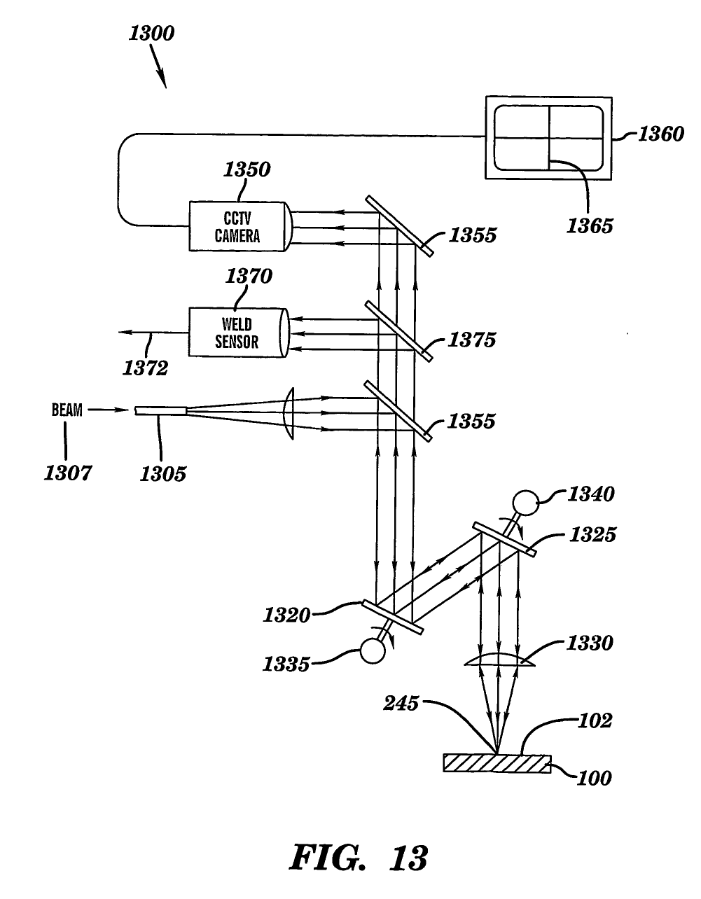

FIG. 13 depicts an exemplary beam laser spot welding beam delivery subsystem 1300, which incorporates a weld quality sensor to provide automated weld quality control. As shown in FIG. 13, the laser spot welding beam delivery subsystems 1300, can be controlled by the processor 512 to automatically adjust and check the quality of a spot weld, such as the spot welds described above for connecting the tabs 125 and 130 to the pads 107 and 109 of the base 105. As shown, the laser spot welding beam delivery subsystem 1300 includes a fiber optic 1305, which directs a beam 1307 through a lens 1310 onto mirror 1315. The mirror 1315 deflects the beam onto first and second movable deflecting mirrors 1320 and 1325, which typically serve as an x-direction deflector and y-direction deflector. The beam is directed by deflectors 1320 and 1325 through a focus lens 1330 and onto the amplifier 100 to form a desired spot weld, eg spot weld 140, at the desired location 245. The deflectors 1320 and 1325 are respectively driven by galvo's 1335 and 1340, in accordance with control signals issued by processor 512.

A closed circuit television (CCTV) camera 1350, co-axially aligned with the beam is also provided. The camera 1350 detects light reflected from the amplifier 100 and deflected by the deflectors 1320 and 1325, and a mirror 1355 onto a sensor (not shown) within the camera 1350. An image of the entire, or more typically only a portion of the amplifier 100, is generated by the camera 1350 from the detected light and displayed on a display monitor 1360, having crosshairs 1365. The monitor 1360 presents the image to the operator for viewing.

As shown in FIG. 13, the laser spot welding beam delivery subsystem 1300 includes a coaxial weld sensor 1370. The sensor 1370 is configured to detect the reflection of the welding beam 1307 off of the amplifier 100. That is, the sensor 1370 may detect the spectral content of the reflected radiation or the time signature of the weld or any appropriate characteristic of the weld. This reflected radiation is directed to the weld sensor 1370 by the Dichroic or partially reflective mirror 1275.

During operations, the reflection of the welding beam 1307 off the work piece, eg amplifier 100, is directed back to the weld sensor 1370. The sensor 1370 detects the reflected radiation from the beam off the work piece and generates a sensor output 1372 to the processor 512. The sensor output provides a signature for the weld, which can be processed to determine whether the weld has a good signature or a bad signature. The processor 512, in accordance with logic stored at memory 514, processes the sensor output 1372 to determine if the formed weld is within a predefined threshold. If so, operations to form another weld in accordance with a defined weld pattern are performed.

If not, the processor 512, in accordance with logic stored at memory 514, can generate commands notifying the operator of the deficiency of the weld formed at the applicable location, or execute a stop command to halt further welding, thereby allowing the operator to make any necessary adjustments prior to proceeding with the next weld. The processor 512 can also be configured to analyze the sensor output to determine what corrective steps are required. For example, the processor could be configured with the logic necessary to determine, based on the sensor output, that the weld beam is out of focus and to automatically adjust the beam focus or the z-axis position of the work surface before proceeding with the next weld in a pattern. The processor might also be configured with the logic necessary to determine, based on the sensor output that a defect exist in the work piece and to automatically adjust the location of the next spot-weld. If desired, a parameter corresponding to the adjustment may be stored to retrain the system, for example as discussed above with reference to FIG. 10. If so, the processor 512 commands during welding operations on later welded work pieces will automatically make the necessary adjustments.

It will also be recognized by those skilled in the art that, while the invention has been described above in terms of one or more preferred embodiments, it is not limited thereto. Various features and aspects of the above-described invention may be used individually or jointly. Further, although the invention has been described in the context of its implementation in a particular environment and for particular purposes, eg spot welding of micro-devices, those skilled in the art will recognize that its usefulness is not limited thereto and that the present invention can be beneficially utilized in any number of environments and implementations, including but not limited to macro-manufacturing environments and optical reading or writing implementations. Accordingly, the claims set forth below should be construed in view of the full breath and spirit of the invention as disclosed herein.

1. An automated system for directing an energy beam to a desired impinge point on a surface of a work piece for processing the work piece, comprising:
a moveable beam reflecting mirror for receiving the energy beam from an energy beam source Band for movably directing the energy beam onto the surface of the work piece;
an imager having a field of view with a line of sight that is substantially centered with respect to the field of view, said imager being configured to provide an image of at least a portion of the surface of the work piece and for providing a video signal corresponding thereto;
a display monitor for displaying the image with an operator movable pointer superimposed thereon;
an input device configured to move the pointer with respect to the image in response to operator movement inputs from the input device and further configured to provide a first operator command signal when an operator selects a first point of the image for directing the energy beam; and
a processor configured to receive the first operator command signal and to determine the image coordinates of the selected first point of the image, and to direct movement of the movable beam reflecting mirror so as to direct the energy beam to the surface of the work piece at an energy beam impinge point that corresponds to the selected first point of the image; and
a memory operatively coupled to the processor and configured to store a pattern of target locations selected using the image, the pattern including the first point as one of the target locations and a plurality of stops.

2. A system according to claim 1 wherein the system is further configured with the line of sight of the imager movably directed onto the surface of the work piece by the movable beam reflecting mirror such that any movement of the reflecting mirrors redirects the line of sight of the imager with respect to the surface of the work piece.

3. A system according to claim 1 wherein the system is further configured with the line of sight of the imager and the energy beam impinge point is substantially coincident at the surface of the work piece.

4. A system according to claim 1 wherein the display monitor includes a fixed location identifier having a position that identifies the energy beam impinge point.

5. A system according to claim 1 further comprising optical elements for focusing the energy beam at the surface of the work piece.

6. A system according to claim 1 further comprising a movable support table and a z-axis motion control device in communication with the processor for moving the work piece along a z-axis.

7. A system according to claim 1 further comprising an energy beam focus sensing device comprising:
a sensor for sensing energy of a focus sensing beam reflected by the surface of the work piece and for providing a sensor output indicative of a focus condition;
wherein the sensor output is delivered to the processor thereby enabling the processor to make a focus correction in response to a poor focus condition.

8. A system according to claim 1 further comprising means for delivering a plurality of energy beams to the surface of the work piece and wherein each of the plurality of energy beams is focused on the surface and directed over the work piece by movement of the moveable beam reflecting mirror.

9. A system according to claim 1 further comprising a visible laser for providing a visible beam impinging onto the work piece at a point coincident with the energy beam impinge point and wherein the visible laser beam is directed over the work piece by movement of the reflecting mirror while remaining coincident with the energy beam impinge point.

10. A system according to claim 1 further comprising a weld quality sensor for providing a weld quality signal indicative of the quality of a weld being performed to the system, and wherein the processor is configured to respond to a bad weld signal from the weld quality sensor.

11. A system according to claim 1, wherein:
the movable pointer is a cursor;
the input device is a mouse having a button;
the operator movement inputs are provided by moving the mouse and thereby moving the displayed cursor with respect to the image to select the first point as a desired energy beam impinge point; and
the first operator command signal provided to select the first point of the image includes pressing the button.

12. A system according to claim 1 wherein the job is a welding job and the target locations are weld locations.

13. A system according to claim 1 wherein the system is further configured to have a drag mode such that:
the first operator input command signal initiates the drag mode;
further operator movement inputs generated by moving the input device move the pointer and the beam reflecting mirror in response thereto, wherein the pointer moves from the first point of the image to a second point of the image; and,
a second operator input command signal is provided when the operator selects the second point, thereby stopping movement of the beam reflecting mirrors and ending the drag mode.

14. A system according to claim 1 wherein:
the processor is configured to generate a thumb nail image showing a larger portion of the work piece than the image generated by the imager; and,
the display monitor is configured, to display the image and the thumb nail image simultaneously.

15. A system according to claim 1 wherein
the processor is further configured to generate symbols for displaying the pattern of target locations in accordance with display signals sent to the monitor.

16. A system according to claim 1 wherein the energy beam comprises a laser beam.

17. A system according to claim 1 wherein the moveable beam reflecting mirror comprises two mirrors configured to direct the energy beam over the surface of the work piece in mutually perpendicular axes.

18. A system according to claim 5 wherein at least one of the optical elements is movable for adjusting the location of a focal point location of the energy beam.

19. A system according to claim 15 wherein
the pattern is changeable by moving a displayed symbol to a new selected location using the input device.

20. A method for directing an energy beam to impinge a work piece at a selected first point, comprising:
displaying an image of the work piece, with a pointer superimposed on the image such that the pointer is movable with respect to the image in response to operator movement commands;
selecting the first point on the image;
providing a first operator command signal to a processor when the first point is selected;
performing a logical operation in the processor for determining an angle for rotating a beam reflecting mirror positioned between the energy beam source and the surface of the work piece, the angle being selected for directing the energy beam to impinge the surface at an impinge point corresponding to the selected point;
repeating the selecting providing and performing for each of one or more additional points thereby defining a pattern of target locations; and
selecting a stop between at least two of the selected points included in the pattern.

21. A method according to claim 20, further comprising:
displaying a spot indicator superimposed on the image at the selected point locations.

22. A method according to claim 20 further comprising
storing a location of each of the selected points in a memory; and,
operatively coupled to the processor.

23. A method according to claim 22 further comprising displaying an impinge spot indicator superimposed on the image at each of the selected points.

24. A method according to claim 20 further comprising:
directing a visible laser beam coaxially with the energy beam so that the visible laser beam and the energy beam impinge the work piece at a coincident impinge point; and,
configuring a camera to display the visible laser beam on a display monitor.

25. A method according to claim 20 further comprising:
directing a focus beam onto the work piece;
sensing focus beam energy reflected from the surface of the work piece with a focus sensor;
providing a focus sensor output signal to the processor;
analyzing the focus sensor output signal with the processor to determine a focus condition; and,
initiating a focus correction action if the focus condition is unacceptable.

26. A method according to claim 20 further comprising:
controlling the z-axis position of the surface of the work piece in accordance with commands received from the processor.

27. A method according to claim 20 further comprising:
determining a focus condition of the energy beam at the surface of the work piece; and,
adjusting a z-axis position of the surface of the work piece to optimize the focus condition prior to processing.

28. A method according to claim 20 further comprising:
directing a plurality of processing beams at the work piece with a plurality of impinge points; and,
processing the plurality of impinge points simultaneously.

29. A method according to claim 20 further comprising:
sensing a quality of the energy beam by providing an energy beam quality sensor in a position to receive radiation reflected from the work piece during processing;
providing a process quality signal to the processor; and,
performing corrective action according to commands generated by the processor in response to receiving a process quality signal from the weld quality sensor indicative of a bad weld.

30. A system according to claim 1 wherein the system allows an operator to inspect the pattern and make changes as required during a job that uses the pattern.

31. A method according to claim 20 wherein selecting a stop between at least two of the selected points included in the pattern allows an operator to inspect the pattern and make changes as required during a job that uses the pattern.

32. An automated system for directing an energy beam to a desired impinge point on a surface of a work piece for processing the work piece, comprising:
a processor configured to determine coordinates of a user selected first point on an image of the work piece, and to control a movable beam reflecting mirror so as to direct an energy beam to the surface of the work piece at an impinge point that corresponds to the user selected point on the image; and
a memory operatively coupled to the processor and configured to store a pattern of user selected points on the image, the pattern including the first point and a stop between at least two of the selected points.

33. The system of claim 32 wherein the system enables both the image and a thumb nail image showing a larger portion of the work piece to be displayed simultaneously on a monitor coupled to the system, thereby enabling a continuing display of the larger portion during system operation.

34. The system of claim 32 wherein the processor is further configured to generate symbols for displaying the pattern of user selected points on the image, where symbols of processed points are distinguished from symbols of non-processed points as the system executes the pattern.

35. The system of claim 34 wherein the pattern is changeable by moving a displayed symbol to a new selected location using an input device.

36. The system of claim 32 further comprising optical elements for focusing the energy beam at the surface of the work piece, wherein at least one of the optical elements is movable for adjusting a focal point location of the energy beam.

37. The system of claim 32 further comprising a z-axis motion control device in communication with the processor for moving the work piece along a z-axis.

38. The system of claim 32 wherein the system allows a user to inspect the pattern and make changes as required during a job that executes the pattern.
